(19) United States
(12) Patent Application Publication
(10) Pub. No.: US 2021/0090359 A1
(43) Pub. Date: Mar. 25, 2021

(54) PREDICTIVE VEHICLE DIAGNOSTIC METHOD

(71) Applicant: We Predict Limited

(72) Inventors: Anthony Peter GRIFFITHS, Newton (GB); Christopher Lee DAVIES, Sketty (GB); James Gareth DAVIES, Ann Arbor, MI (US); Stephen David NORRIS, London (GB); Patrick James TUDOR, Sketty (GB); Timothy Peter DAVIS, Warwick (GB); Kelly Marie NOCK, Cardiff (GB); Steffan Rees, London (GB)

(21) Appl. No.: 17/032,271

(22) Filed: Sep. 25, 2020

Related U.S. Application Data
(63) Continuation of application No. PCT/EP2019/057640, filed on Mar. 26, 2019.

(30) Foreign Application Priority Data
Mar. 27, 2018 (GB) 1804886.8
Mar. 27, 2018 (GB) 1804888.4
May 31, 2018 (GB) 1808881.5

(51) Int. Cl. G07C 5/08; G06N 5/04; G06N 20/00; B60R 16/023

(52) U.S. Cl. CPC G07C 5/0808; G06N 5/04; B60R 16/0234; G07C 5/0841; G06N 20/00

(57) ABSTRACT

A computer-implemented method of predicting vehicle faults, the method comprising, at a data processing stage: receiving: i) sets of telematics data each associated with a vehicle identifier, and ii) a vehicle fault dataset, which records historic vehicle fault events, wherein the vehicle fault events are associated in the datasets with cooperating vehicle identifiers; for each of the vehicle identifiers, determining i) a feature object by processing the associated set of telematics data to determine at least one driving style parameter therefrom, the feature object comprising the at least one driving style parameter, and ii) a training label for the feature object based on one or more of the vehicle fault events associated with that vehicle identifier; and using the feature objects and their training labels to train a predictive component, executed at the data processing stage, to learn causal associations between the driving style parameters and the vehicle fault events, such that a feature object comprising at least one target driving style parameter, associated with a target vehicle, inputted to the trained predictive component causes the predictive component to output a corresponding vehicle fault prediction.

### CROSS-REFERENCE TO RELATED APPLICATIONS

The present application is a bypass continuation application of International Application No. PCT/EP2019/057640, filed on Mar. 26, 2019, which in turn claims claims priority to GB Application No. 1804886.8, filed Mar. 27, 2018, GB Application No. 1804888.4, Filed Mar. 27, 2018, and GB Application No. 1808881.5, filed May 31, 2018. Each of these applications is incorporated herein by reference in its entirety for all purposes.

### TECHNICAL FIELD

This disclosure relates to vehicle telematics.

### BACKGROUND

Most modern vehicles are equipped with some form of on-board diagnostics data collection system that records data about the state of the vehicle for use in performing diagnostics (diagnostics data). This is generally in the form of sensor readings, though at least some of it can come from other sources, such as self-reporting from on-board computers. As automotive technology develops, more and more aspects of a vehicle's state are monitored and recorded using increasingly sophisticated sensor systems and other monitoring components, to the extent that, in some of the newer vehicles available today, in its raw form, the volume of raw diagnostics data that is generated can exceed 1 Tb per day for a single vehicle.

For some time, vehicles have been equipped with on-board information extraction functionality, whereby a vehicle can extract, from the raw diagnostics data, what is considered, from an engineering perspective, to be the most relevant information, and store it in a convenient form. This “summarizing” of the raw data is a form of self-diagnosis and reporting, which is referred to in the automotive industry as on-board diagnostics (OBD). An on-board diagnostics data collection system having such OBD functionality may be referred to as an OBD system herein.

An OBD system may provide an event-driven summary of the raw diagnostics data it collects, by recording the occurrence of certain types of event. These are specific types of event that are predetermined based on human engineering knowledge and expertise. This can be based on a system of “diagnostic trouble codes”, where each evet type is associated with a unique DTC. This provides a (to some extent) standardized mechanism for detecting and reporting such events. The output of a DTC analysis over time is a record of which DTCs have been triggered at which times, which is a form of summarized (as opposed to raw) diagnostics data as those terms are used herein. In this context, the event that triggers a DTC code may be referred to as a DTC event.

Even the less sophisticated OBD systems in use today use extensive DTC sets. For example, the OBD2 specification provides a widely-adopted set of “basic” DTCs (also referred to as OBD2 parameter identifiers, or OBD2-PIDs), which are nonetheless extensive. Many manufactures also add their own DTCs on top of this, and as such the DTC sets used in certain vehicles today can be vast. DTC sets can cover factors as diverse as vehicle mechanics (pedal position, throttle position, wheel alignment etc.), fuel/fuel-tank state (composition, temperature, pressure, level, fuel-air ratio, solenoid state), ambient air, on-board computer errors (failed read/write operations, communication errors etc.), vehicle speed/acceleration/breaking, exhaust pressure, ignition, service interval (i.e. time since last service), battery state, engine state (engine temperature, RPM, engine torque), coolant temperature etc. Accordingly, even though a vehicle's DTC records are an event-driven summary of the raw diagnostics data, they still provide a wealth of information about the vehicle's historic state and performance.

The term “telematics” is sometimes used in this context as an umbrella term for diagnostics and monitoring. Telematics often has a geographic element, and can for example take the form of diagnostics data having associated location data, such as GPS or similar, which can be used to map a vehicles location over time together with any changes in its internal state as it travels. However, in its broadest sense, the term telematics as used herein can refer to any sensor or (other) diagnostics data collected by a vehicle's on-board data collection system, and is not restricted in this sense. That is, the terms telematics and diagnostics in relation to data are synonymous herein.

### SUMMARY

A vehicle's on-board sensors produce a vast amount of telematics data for every journey undertaken. For example, for a single journey, e.g. from the time the engine was switched on until the engine was switched off, the on-board sensors may monitor the vehicle's speed, acceleration, braking, etc., together with the complex state of its numerous systems and components. In accordance with the invention, a set of driving style parameters are determined from the telematics data, e.g. average speed, maximum acceleration, total brakes per journey, etc., for each vehicle in a population of vehicles. These parameters provide an insight into a particular driver's driving style that can be compared with the driving style parameters of other drivers to identify distinct driving groups each corresponding to at least a particular driving style. For example, the parameters may indicate that the driver often drives a high speeds, brakes aggressively, idles for long periods of time, etc.

The driving style parameters for each vehicle in the population are linked with vehicle faults that have occurred in and have been recorded for that same vehicle. A vehicle fault may be, for example, a worn-out brake pad or damaged shock absorbers.

According to a first aspect of the invention, the linked datasets are provided as training data to train a predictive model (component). The model is trained to infer causal connections or relationships between the data in the linked datasets. This is a form of supervised learning.

That is, a supervised learning method can be used to produce a predictive model from labelled training data, in the form of feature objects comprising driving style parameters derived from at least the telematics data, having training labels (expected output values or “significance labels”) derived from the vehicle fault event records. Together these constitute training examples from which the model can generalize.

According to the first aspect of the invention, a computer-implemented method of predicting vehicle faults comprises, at a data processing stage: receiving: i) sets of telematics data each associated with a vehicle identifier, and ii) a vehicle fault dataset, which records historic vehicle fault events, wherein the vehicle fault events are associated in the datasets with cooperating vehicle identifiers; for each of the vehicle identifiers, determining i) a feature object by processing the associated set of telematics data to determine at least one driving style parameter therefrom, the feature object comprising the at least one driving style parameter, and ii) a training label for the feature object based on one or more of the vehicle fault events associated with that vehicle identifier; and using the feature objects and their training labels to train a predictive component, executed at the data processing stage, to learn causal associations between the driving style parameters and the vehicle fault events, such that a feature object comprising at least one target driving style parameter, associated with a target vehicle, inputted to the trained predictive component causes the predictive component to output a corresponding vehicle fault prediction.

As well as the driving style parameters, the predictive model may also learn causal associations between vehicle fault events and other types of parameter of the feature objects, such as environmental parameters and/or vehicle attributes.

In a second aspect of the invention, feature objects are grouped into driving style groups, which can be based on unsupervised machine learning.

According to the second aspect of the invention, a system for predicting vehicle faults comprises: a computer interface configured to receive: i) sets of telematics data each comprising a vehicle identifier, and ii) a vehicle fault dataset, which records historic vehicle fault events, wherein the vehicle fault events are associated in the datasets with cooperating vehicle identifiers; a processing component configured to process each of the sets of telematics data to determine a feature object comprising at least one driving style parameter; a grouping component configured to group the feature objects into a plurality of driving style groups, by comparing at least the driving style parameters of the feature objects; and a linking component configured to link each of the driving style groups with one or more of the historic vehicle fault events based on the associated vehicle identifiers.

An unsupervised learning method can be used to produce a predictive model from unlabelled data. That is, a classification or categorisation of the training data is not provided. One example of an unsupervised learning method is cluster analysis, which is used for exploratory data analysis to find hidden patterns or grouping in data. The clusters are modelled using a measure of similarity. In an example, the predictive model receives multiple sets of linked driving style parameters and vehicle faults, and from these linked sets, the model infers the relationship between two parameters and faults in each set. Once trained, the algorithm can take new parameters and predict determine an associated vehicle fault.

Clustering is the task of grouping a set of objects in such a way that objects in the same group (called a cluster) are more similar (in some sense) to each other than to those in other groups (clusters). For example, the predictive model may apply clustering techniques to effectively group together drivers exhibiting similar driving styles (e.g. drives a high speeds, brakes aggressively, idles for long periods of time), separately from the groups of drivers who, for example, consistently keep to speed limits, brake smoothly and rarely idle. Depending on the predictive model, the groups may or may not be known beforehand. That is, the predictive model may be left to find structure within the provided datasets in order to cluster the driving style parameters.

In addition, by linking the two datasets (driving parameters and vehicle faults), groups of comparable driving styles and associated vehicle faults can be used to produce a driving style (behaviour) profile and corresponding vehicle fault profile. In some cases, this may involve aggregating the driving style parameters and linked faults in the driving style groups. In other words, the vehicle fault events across different vehicles are grouped based on similarity of driving styles, to provide a statistically significant sample of historic vehicle fault events for each driving style.

Another one of the advantages of the invention is that it provides an insight into which particular vehicle faults are typical of certain driving styles/behaviours. The invention allows this useful information to be extracted from a vast and seemingly disparate collection of sensor and fault data, and does not rely on human knowledge about the likely cause of vehicle faults and therefore does not suffer from the problem of human bias. In embodiments, in addition to driving style, the grouping may also take into account attributes of the vehicles themselves, such that each group corresponds not only to a particular driving style but also a particular type or class of vehicle. For example, a driving style profile may indicate that a vehicle driven for long distances with aggressive acceleration and excessive braking is likely to require brake pad replacement. Of course, it might be obvious for an engineer to logically deduce this particular causal relationship, however the invention does not require such logical deduction. Rather, the causal relationship emerges, for example, by grouping and aggregating actual recorded vehicle fault events according to driving style. A benefit is that, in addition to combining expected causal links between driving style and vehicle faults, it can also reveal the existence of unexpected causal links that even a skilled engineer might not have been able to anticipate through logical deduction in practice. The invention may therefore predict both anticipated and unanticipated vehicle faults for a vehicle before it occurs based on the associated driving style.

Without this predictive approach, the first time a vehicle owner, manufacturer or mechanic becomes aware of a vehicle fault is when the vehicle has already developed the fault and requires maintenance or repair. A mechanic, for example, must begin to work “backwards” to diagnose the case of the vehicle fault, e.g. by drilling down into extensive DTC records to try to determine if an observed vehicle fault can be attributed to some aspect of the driver's driving style. This is heavily reliant on the personal knowledge and expertise of the mechanic, and as such there will always be some subjective elements to his/her analysis. This is also a manual process.

The predictive approach of the invention is in direct contrast to this reactive analysis. That is, the invention is about predicting significant vehicle faults based on historic telematics data and linked historic vehicle fault data, so that future such faults can be corrected or mitigated early or prevented altogether though appropriate vehicle maintenance (predictive analysis), in contrast to diagnosing the cause of a significant vehicle fault after it has occurred based on the diagnostic event records leading up to that point (reactive analysis). Moreover, unlike the manual process outlined above, the solution provides this capability at scale and in a timely manner, in an automated or largely automated fashion.

In the described examples, the vehicle fault events are repair events, i.e. corresponding to repair operations that were performed on the vehicles in question and recorded in the vehicle fault dataset, e.g. at a garage or other vehicle repair facility. However, the invention is not limited in this respect. For example, the vehicle fault events could be vehicle breakdown events; that is, vehicle breakdowns recorded in the vehicle fault data set, recorded for example by a roadside assistance service. In that case, significance is measured in terms of how likely a given type of diagnostic warning event is to be followed by a roadside breakdown event.

In embodiments the method may comprise: inputting a feature object comprising the target set of driving style parameters to the trained predictive component; and outputting the corresponding vehicle fault prediction, by the predictive component.

The vehicle fault prediction may be outputted to a user via an output device.

The corresponding vehicle fault prediction may comprise a significance value denoting a likelihood of a vehicle fault occurring with the target vehicle.

The training labels may be determined based on the types of the vehicle fault events such that the significance value denotes a likelihood of a specific type or types of vehicle fault event occurring.

The training labels may be determined based on timing or usage values associated with the historic vehicle fault events such that the significance value denotes a likelihood of the vehicle fault occurring with the target vehicle within a predetermined period of time and/or a predetermined usage interval.

The timing values may be vehicle age values such that the predetermined period of time corresponds to a vehicle age range.

The training labels may be vectors having components corresponding to different time or usage intervals.

The training labels may be determined based on recorded resource values for the historic vehicle fault events such that the corresponding vehicle fault prediction is an expected vehicle fault resource value for the target vehicle.

The predictive component may be a regression component.

The predictive component may be a probabilistic classifier.

The predictive component may be a deterministic classifier.

The predictive component may be trained by optimizing a function of the training labels (significance labels) and the output of the predictive component during the training. The function may be optimized by iteratively adapting model parameters of the predictive component based on the significance labels and the output of the predictive component during the training.

Another aspect of the invention provides a system for predicting vehicle faults, the system comprising: a computer interface configured to receive: i) sets of telematics data each comprising a vehicle identifier, and ii) a vehicle fault dataset, which records historic vehicle fault events, wherein the vehicle fault events are associated in the datasets with cooperating vehicle identifiers; a processing component configured to process each of the sets of telematics data to determine a feature object comprising at least one driving style parameter; a grouping component configured to group the feature objects into a plurality of driving style groups, by comparing at least the driving style parameters of the feature objects; and a linking component configured to link each of the driving style groups with one or more of the historic vehicle fault events based on the associated vehicle identifiers.

The system may comprise a predictive component configured to receive a feature object of a target vehicle comprising at least one driving style parameter, match the feature object of the target vehicle to at least one of the driving style groups, and output a vehicle fault prediction for the target vehicle based on the vehicle fault events linked to the at least one driving style group, wherein the processing component may be configured to determine the feature object for the target vehicle by processing a set of telematics data received for the target vehicle.

The system may comprise a user interface for accessing vehicle fault information for each of the driving style groups, the vehicle fault information being derived from the one or more vehicle fault events to which the driving style group is linked.

The grouping component may be configured to group the feature objects using an unsupervised machine learning algorithm.

The system may be configured to aggregate, for each of the driving style groups, its constituent driving style parameter sets to determine a representative driving style profile.

The system may be configured to aggregate, for each of the driving style groups, the historic vehicle fault events linked to it, to determine a representative historic vehicle fault profile, wherein the vehicle fault prediction is based on the representative historic vehicle fault profile of the at least one driving style group.

Said aggregating of the linked historic vehicle fault events may comprise determining a significance value for at least one type of vehicle fault event, the representative historic vehicle fault profile comprising the likelihood and an associated identifier of the type of vehicle fault event.

The historic vehicle fault profile may comprise significance values for different types of vehicle fault events in association with respective vehicle fault event type indications.

The prediction component may comprise a classifier configured to match the feature object of the target vehicle to the at least one driving style group using a classification algorithm.

Said matching may comprise determining a matching score between the feature object of the target vehicle and the at least one driving style group.

The vehicle fault prediction may comprise a likelihood of at least one type of vehicle fault occurring with the target vehicle, wherein the likelihood may be determined based on the representative historic vehicle fault profile of the at least one driving style group.

The system may comprise a plurality of predictive components, each corresponding to one of the driving style groups, wherein each of the predictive components may be trained using the feature objects of the driving style group to which is corresponds and the one or more vehicle faults linked to that group.

The one or more vehicle faults may be used to determine training labels for that driving style group.

Each of the feature objects may also comprise at least one vehicle attribute.

The vehicle attributes may be determined from vehicle records having cooperating vehicle identifiers.

The at least one vehicle attribute may comprise at least one of: i) an age of the vehicle, ii) a mileage of the vehicle, iii) a vehicle manufacturer, iv) a vehicle model, v) a vehicle engine type, and vi) a vehicle transmission type.

Each of the feature objects may also comprise at least one environmental parameter.

The environmental parameters may be determined from environmental records having cooperating vehicle identifiers.

The driving style parameters may comprise at least one of: i) a vehicle speed metric, ii) a driving distance metric, iii) an vehicle acceleration metric, iv) a vehicle engine metric, and v) a vehicle braking metric.

An alert may be outputted, by an alert component, for the target vehicle comprising the vehicle fault prediction.

The alert may be outputted in response to a likelihood of the vehicle fault prediction being above a threshold.

The alert may comprise the determined likelihood and an identifier of at least one type of vehicle fault to which it relates.

The alert may be output to a user of the target vehicle.

Each set of telematics data may comprise data from a set of on-board vehicle sensors of a vehicle.

The vehicle fault dataset may be a vehicle repair dataset and the vehicle fault events may be vehicle repair events.

The vehicle fault dataset may be formed of warranty claim records.

The vehicle fault dataset may be a vehicle breakdown dataset and the vehicle fault events may be vehicle breakdown events.

The vehicle fault dataset may be a vehicle service dataset and the vehicle fault events may be vehicle service records.

The driving style parameters may comprise at least one of: a total number of journeys, a total number of days, a number of journeys per day, a time per journey, a journey time per day, a moving time per journey, a moving time per day, a distance covered per journey, a distance covered per day, an average speed, a maximum speed, an average moving speed, a maximum moving speed, an average acceleration, a maximum acceleration, an average deceleration, a maximum deceleration, a total number of brakes per journey, a total number of brakes per day, an average engine revolutions per minute (RPM), a maximum engine RPM, an average engine RPM during acceleration, a maximum engine RPM during acceleration, an average engine RPM at constant speed, and a maximum engine RPM at constant speed.

Another aspect of the invention provides a computer-implemented method of predicting vehicle faults, the method comprising implementing, at a data processing stage, the following steps: receiving diagnostics data (telematics data) and associated timing data collected from a plurality of vehicles; receiving vehicle fault data recording fault events experienced by at least some of the vehicles, each vehicle fault event having an associated timing; for each of the vehicles, determining a significance label for at least one piece of diagnostics data collected that vehicle, the significance label indicating whether or not that vehicle has experienced a fault event within a prediction window; and using the pieces of diagnostics data and their significance labels to make a vehicle fault event prediction for a target piece of diagnostics data.

In embodiments, the pieces of diagnostics data and their significance labels may be used to train a predictive component, executed at the data processing stage, to learn causal associations between pieces of diagnostics data and vehicle fault events, wherein the vehicle fault event prediction is outputted by the trained predictive component based on the target piece of diagnostics data.

The vehicle fault event prediction may comprise a significance value for the target piece of diagnostics data, denoting the likelihood of a vehicle fault event occurring within the prediction window given the target piece of diagnostics data.

The significance value may denote the likelihood of a vehicle fault event occurring within the prediction window as defined relative to a timing associated with the target piece of diagnostics data.

Each piece of diagnostics data may be a portion of diagnostics data collected within a history window.

The history window may have a fixed length.

The history window may have a variable length. For example, the history window length for each portion of diagnostics data may be provided as an input to the predictive component.

Each piece of diagnostics data may be in the form of an individual diagnostics warning event.

In embodiments, the method may comprise: processing each of the pieces of diagnostics data to generate a set of summary data therefrom, wherein the predictive component is trained using the sets of summary data and the associated significance labels; and processing the target piece of diagnostics data to determine a set of summary data therefrom, wherein the vehicle fault event prediction is outputted by the trained predictive component based on the set of summary data determined from the target piece of diagnostics data.

Each set of summary data may comprise one or more driving style parameters.

The diagnostics data received at the data processing stage may comprise a sequence of diagnostic warning events.

The diagnostics data received at the data processing stage may comprise raw diagnostics data.

The method may comprise a step of performing an analysis of the diagnostics data independently of the vehicle fault data, wherein the determining step and/or the using step are performed in dependence on the analysis.

The analysis may comprise at least one of the following: a statistical analysis, an unsupervised machine learning analysis, and a topological data analysis.

The predictive component may be trained by optimizing a function of the significance labels and the output of the predictive component during the training. The function may be optimized by iteratively adapting model parameters of the predictive component based on the significance labels and the output of the predictive component during the training.

Each significance label may indicate whether or not that vehicle has experienced a fault event within the prediction window.

Each of the vehicle fault events may be associated with a resource value and each significance label is determined based on the resource value associated with any vehicle fault event experienced in the prediction window, wherein the vehicle fault prediction may comprise a predicted resource value for the prediction window.

The method may be performed in real-time.

Another aspect of the invention provides a computer-implemented method of predicting vehicle faults, the method comprising implementing, at a data processing stage, the following steps: receiving diagnostics data collected from a plurality of vehicles; receiving vehicle fault data recording fault events experienced by the vehicles; for each of the vehicles, determining, for at least one piece of diagnostics data collected from that vehicle, a significance label based on the vehicle fault data for that vehicle; and using the pieces of diagnostics data and their significance labels to make a vehicle fault event prediction for a target piece of diagnostics data.

The method may comprise: determining that the vehicle fault prediction (vehicle fault event prediction) meets a significance criterion; and in response to that determination, performing a maintenance operation on the target vehicle. For example, that a significance value of the prediction exceeds a significance threshold.

In performing the maintenance operation, a fault with at least one component of the target vehicle may be identified and the identified component may be adjusted, repaired or replaced to correct or mitigate the fault.

Each fault event may have been identified by manual inspection of the vehicle or machine in which it occurred.

Another aspect of the invention provides a data processing stage comprising: electronic storage configured to store computer readable instructions; and one or more processors coupled to the electronic storage and configured to execute the computer readable instructions, the computer readable instructions being configured, when executed on the one or more processors, to implement the method of any preceding claim.

Another aspect of the invention provides a computer program product comprising computer readable instructions stored on a computer readable storage medium and configured, when executed at a data processing stage, to implement the method of any preceding claim.

Reference is made to United Kingdom patent application, filed by the Applicant on 27 Mar. 2019 and having the title “Vehicle Diagnostics” and Application No. 1804888.4 (the 410037 GB application), which is incorporated herein by reference in its entirety.

Each set of summary data referred to above may comprise one or more diagnostic warning event counts. Additionally or alternatively, the receiving step may comprise receiving the diagnostics data and associated timing data collected from a plurality of vehicles, and the prediction time widow may be defined relative to a timing associated with the piece of diagnostics data. The one or more diagnostic warning event counts can be determined in the manner disclosed in the 410037 GB application. That document discloses a method in which significance labels (training labels) are assigned to portions of vehicle diagnostics data (telematics data) based on vehicle fault data within a prediction window defined relative to a timing associated with that piece of diagnostics data. For example, the piece of diagnostics data can be DTC event or snapshot of DTC history, and the prediction window the following month.

### BRIEF DESCRIPTION OF FIGURES

For a better understanding of the present invention, and to show how embodiments of the same may be carried into effect, reference is made to the following figures in which:

FIG. 1 shows a schematic block diagram that is generally representative of a modern vehicle;

FIG. 2 shows a schematic block diagram of a data processing stage configured to determine driving style profiles and linked vehicle fault profiles;

FIG. 3 schematically illustrates the grouping of driving style parameters to determine a driving style profile;

FIG. 4 shows a schematic block diagram of a data processing stage configured to determine a matching driving style profile for a target vehicle;

FIG. 5 shows a schematic block diagram of an alert system for outputting an alert to a user of the target vehicle;

FIG. 6 shows an example set of driving style parameters and vehicle attributes used to determine a risk of a vehicle fault for two target vehicles;

FIG. 7 shows an example speed profile derived from the telematics data of a vehicle;

FIG. 8 shows an example acceleration profile derived from the telematics data of a vehicle;

FIG. 9 shows example journey behaviour profiles derived from the telematics data of a vehicle;

FIG. 10 shows two example sets of telematics data received for two different vehicles;

FIG. 11 shows driving style parameter sets of ten different vehicles, each set derived from the telematics data of a respective vehicle;

FIG. 12 shows additional driving style parameter sets of ten different vehicles, each set derived from the telematics data of a respective vehicle;

FIG. 13 illustrates how the driving style parameters of two vehicles can be used to compare the driving behaviour of the two vehicles;

FIG. 14 illustrates an example of how a suitable feature vector may be assigned to a vehicle identification number (VIN);

FIG. 15 illustrates an example of how a probabilistic classification model may be trained to make vehicle fault predictions; and

FIG. 16 illustrates an example of how a supervised learning model may be trained to make vehicle fault predictions.

### DETAILED DESCRIPTION

Embodiments of the invention are describe in detail below. First, some useful context to the invention is provided.

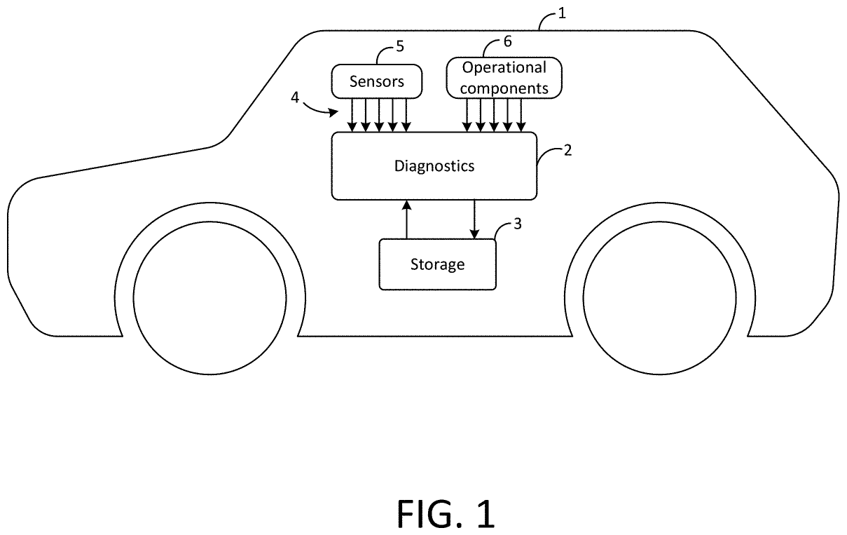

FIG. 1 shows a highly schematic block diagram that is generally representative of a typical modern vehicle 1 having OBD functionality. The vehicle 1 is shown to comprise an OBD system 2 having access to on-board electronic storage 3. The OBD system 2 can be a functional component of the vehicle 1 representing OBD functionality implemented by the vehicle's on-board computer system.

The OBD system 2 collects various telematics data, as represented by the set of inputs labelled 4. The telematics data 4 collected by the OBD system 2 comprises raw telematics data collected from on-board sensors 5, which are coupled to the OBD system 2 which can be arranged to monitor essentially any desired property of the vehicle 1 or its various subsystems and components. The OBD system 2 can also be coupled to other on-board data sources of the vehicle 1, such as other operational components 6 (physical or software) of the on-board computer system, and the telematics data 4 can comprise data collected from such sources.

The telematics data is representative of the vehicle's internal state over time, and can also include location, speed/velocity and/or acceleration data, e.g. collected via GPS or similar.

The on-board sensors 5 may monitor, amongst others, the following vehicle data: speed, distance driven, time driven, acceleration, deceleration, engine RPM, temperature, engine temperature, engine events (e.g. on, off), engine on time (e.g. whilst stationary, whilst moving), braking (number of times, braking force).

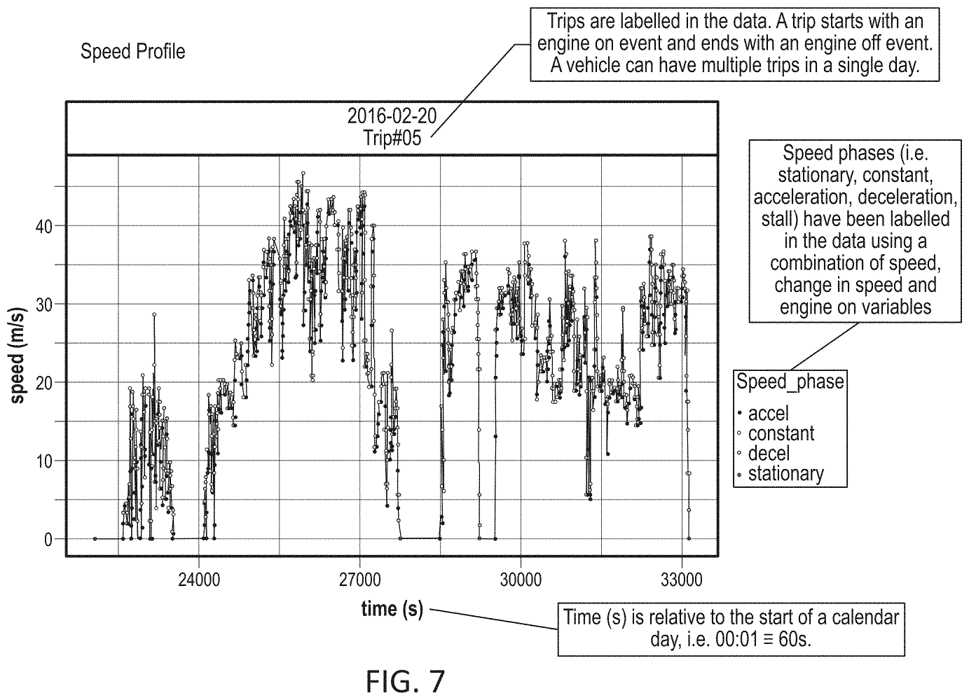

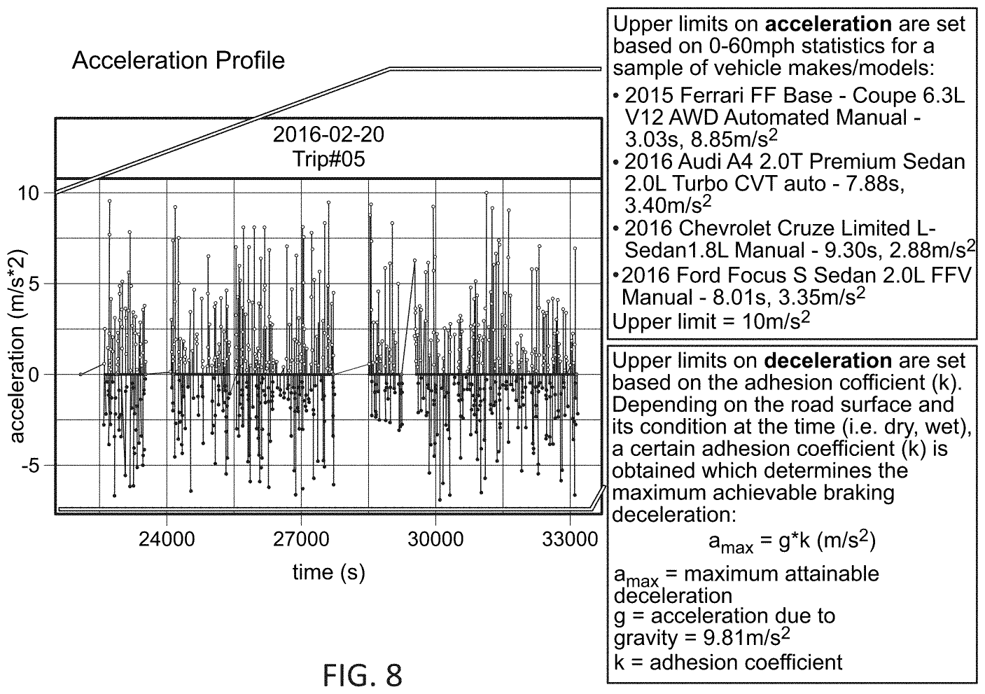

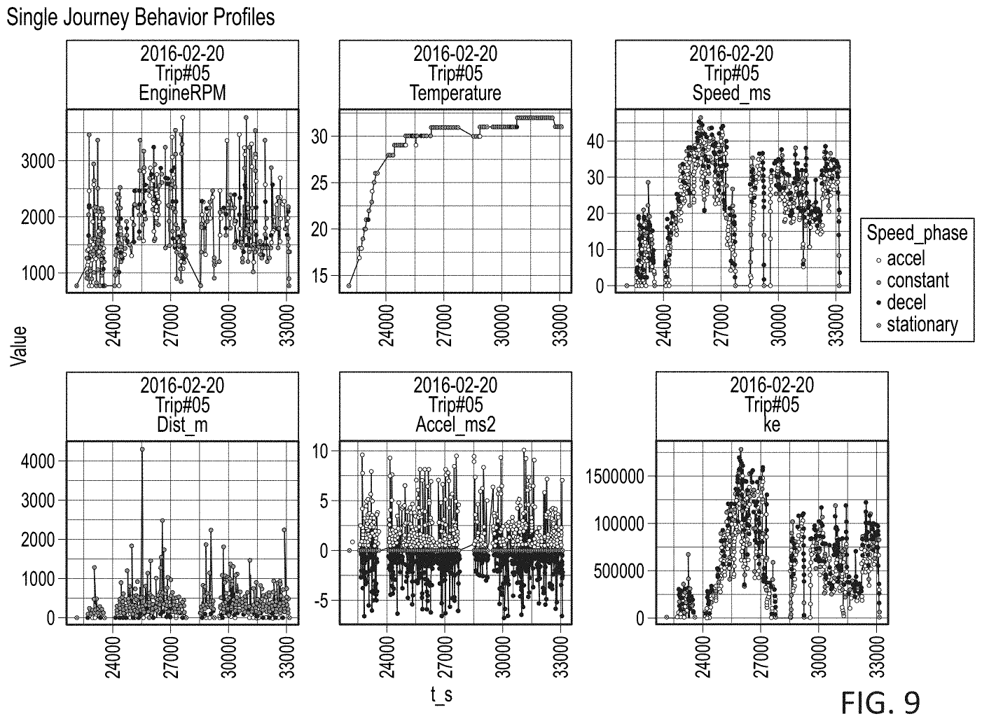

For example, FIG. 7 shows an example of speed telematics data collected from a vehicle to build the vehicle's speed profile. In this example, the profile shows how the vehicle goes through different speed phases (e.g. acceleration, deceleration, stationary, stalled) over time. The speed profile is made up of numerous trips (or journeys), with a trip starting with an engine on event and ending with an engine off event. A vehicle can have multiple trips in a single day. Similarly, FIG. 8 shows an example of acceleration telematics data used to build the vehicle's acceleration profile.

FIG. 9 shows further examples of the data contained in the telematics dataset. Here, respective profiles for the vehicle's engine RPM, temperature, speed, distance, acceleration and the number of engine on events for a single journey are shown. This data can be used to determine driving style parameters, as discussed below.

Embodiments of the invention will now be described by way of example only. As noted above, although the following is described with reference to vehicle repair events, the description applies equally to other types of vehicle fault event. That is, the description applies equally to other forms of vehicle fault data set and not just vehicle repair datasets.

Driving Style Profiles

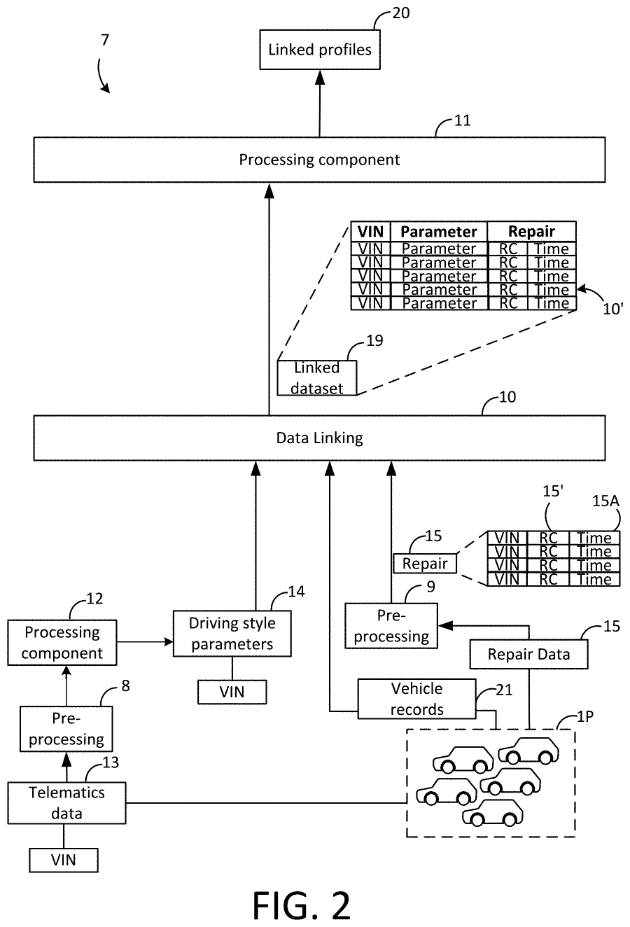

FIG. 2 shows a schematic block diagram of a data processing stage 7, shown to have a telematics data pre-processing component 8, a repair data pre-processing component 9, a data linking component 10, and first and second processing components 11, 12. These components 8-12 are functional components of the data processing stage, i.e. they represent functions that are carried out according to computer-readable instructions (software) executed on one or more processing units of the data processing stage (such as CPUs, GPUs etc.).

A telematics dataset 13 undergoes processing by the first processing component 12 to generate a set of driving style parameters 14. It does this for each vehicle in a population of vehicles 1P for which the analysis is being performed, so as to generate a set In particular, the processing component 12 takes, for example, raw speed data and determines parameters such as, average speed, maximum speed, average moving speed, maximum moving speed. These parameters may be determined, for example, per journey or per day. A journey begins with the vehicle's engine being switched on and ends with the vehicle's engine being switched off.

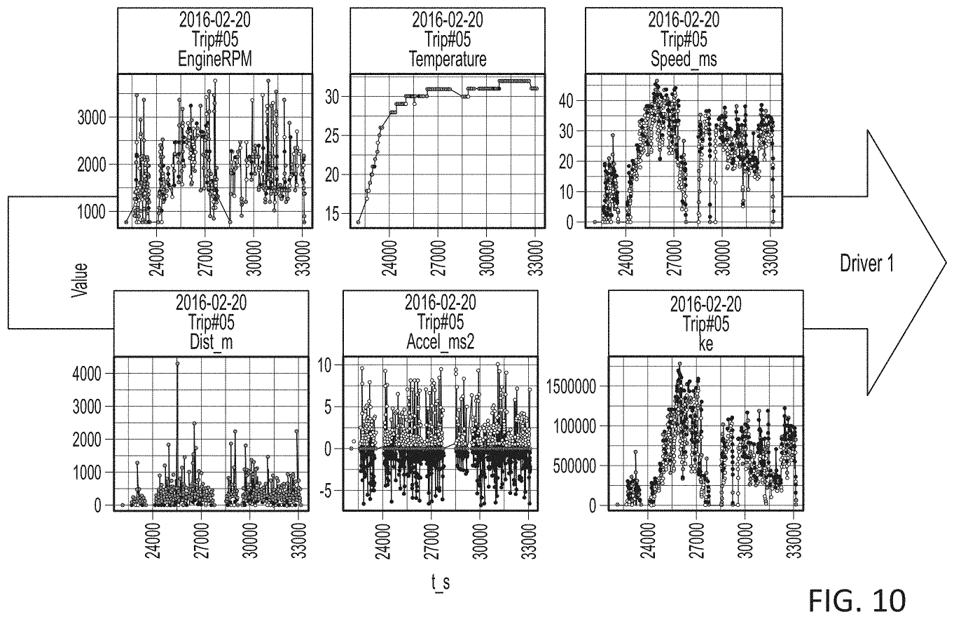

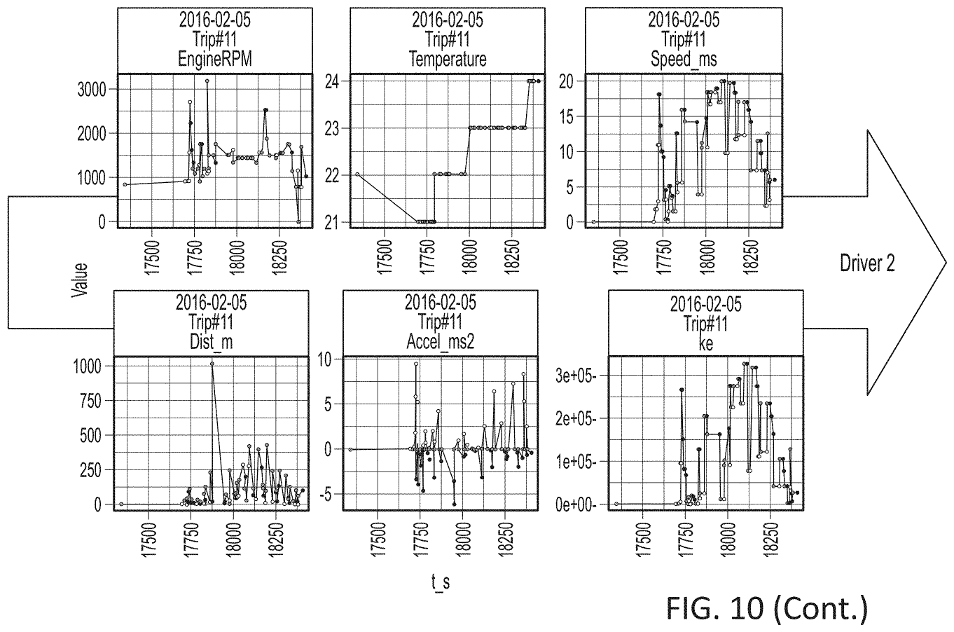

FIG. 10 shows two sets of telematics data received for two different vehicles. Both sets include respective versions of the telematics profiles shown in FIG. 9. These profiles are then used to determine one or more of the total, average, minimum and maximum of at least one of: the distance travelled, speed, acceleration, engine RPMs, engine on events, engine on time, engine on time spent moving, brake events and stall event. These metrics may be determined on either of a per journey or per day basis.

The data linking component 10 receives, as inputs, the set of driving style parameters 14 for each vehicle in the population of vehicles 1P for which the analysis is being performed, and a vehicle fault dataset 15 for the same population of vehicles 1P.

Each vehicle 1 within the population 1P is uniquely identified by a vehicle identifier (ID), in the form of a vehicle identification number (VIN). As is known in the art, a VIN is a unique code that is used to identify an individual vehicle 1 throughout its life. Each set of telematics data 13 is associated with the VIN of the vehicle fault from which it has been collected to allow it to be linked to other data for that vehicle, as described later. The set of driving style parameters 14 derived therefrom is specific to that vehicle and remains associated with its VIN.

The driving style parameter set 14 comprises driving style parameters derived from the telematics data of the kind described above with reference to FIGS. 1, 7, 8 and 9, each of which is associated with a VIN and records a driving style parameter 14 associated with the corresponding vehicle of the population 1P. Whilst knowledge of the timing of the repairs can be useful, it is not required to carry out the invention, as will be apparent in view of the teaching presented herein.

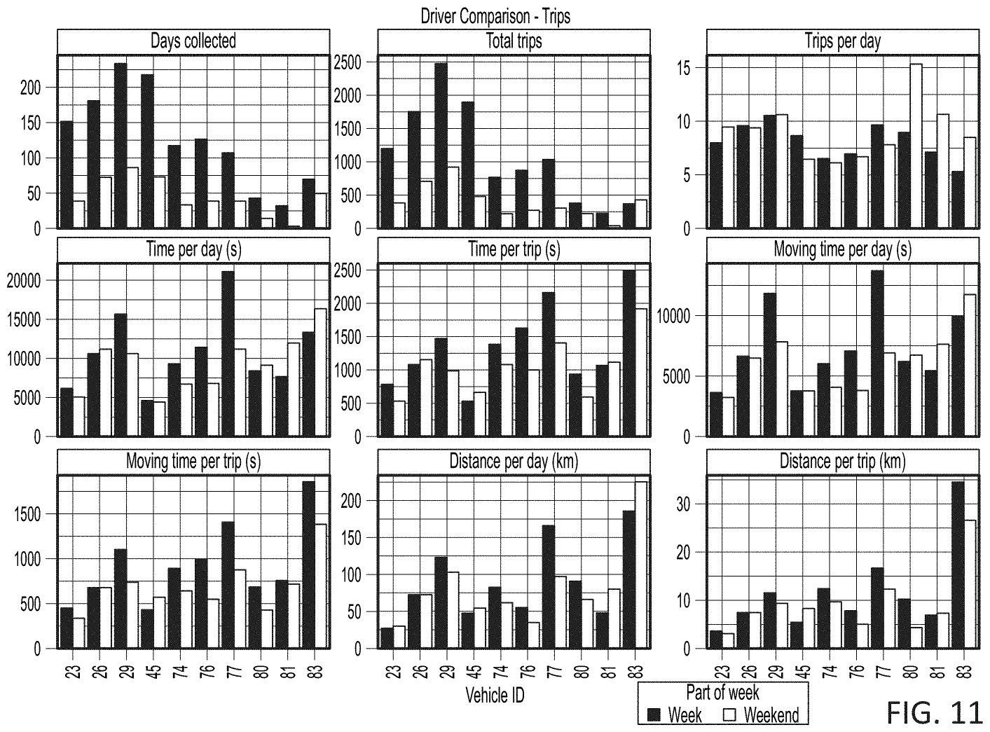

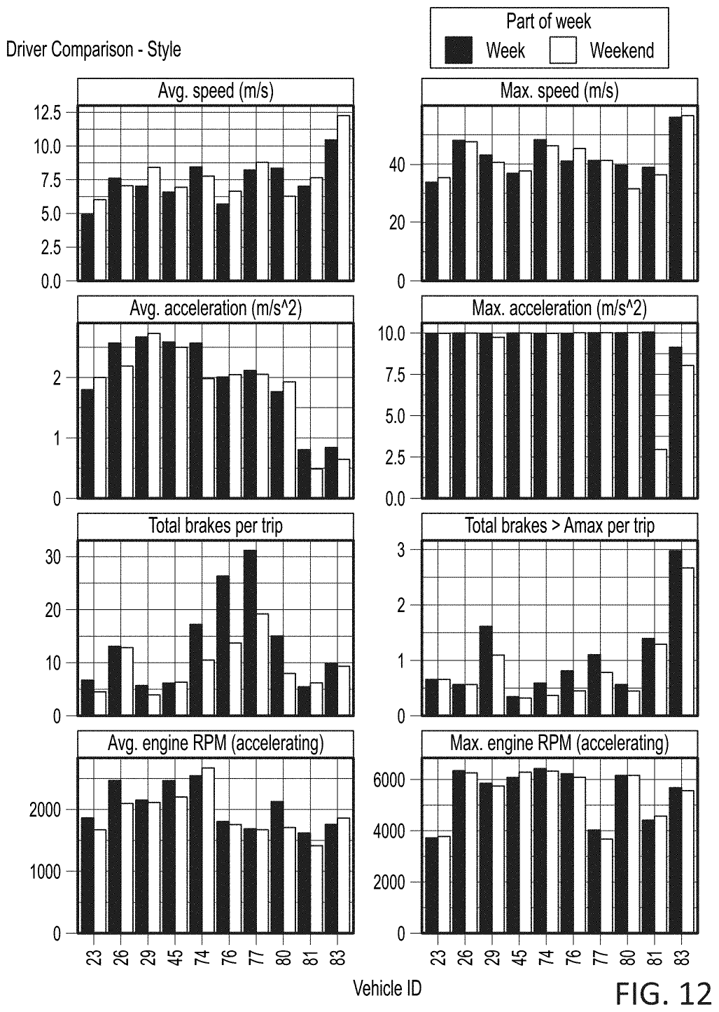

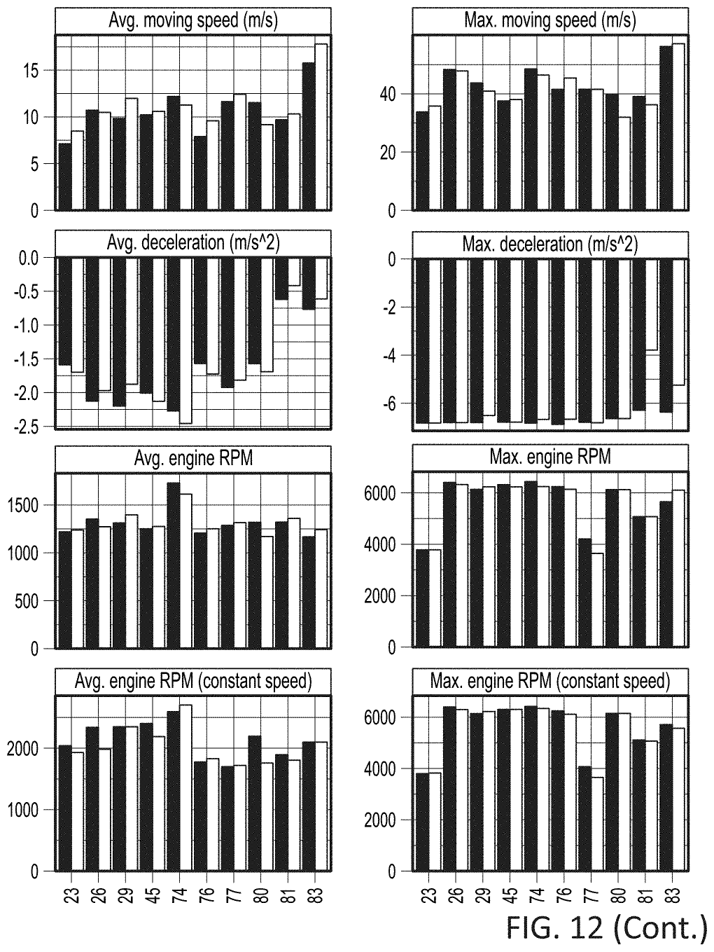

For example, FIG. 11 shows driving style parameter sets of 10 different vehicles, each set derived from the received telematics data. In this example, the driving style parameters (such as journeys per day, moving time per journey) are split by weekday and weekend. That is, a driving style parameter may be the total moving time per weekend journey. FIG. 12 shows more driving style parameter sets collected for the same vehicles.

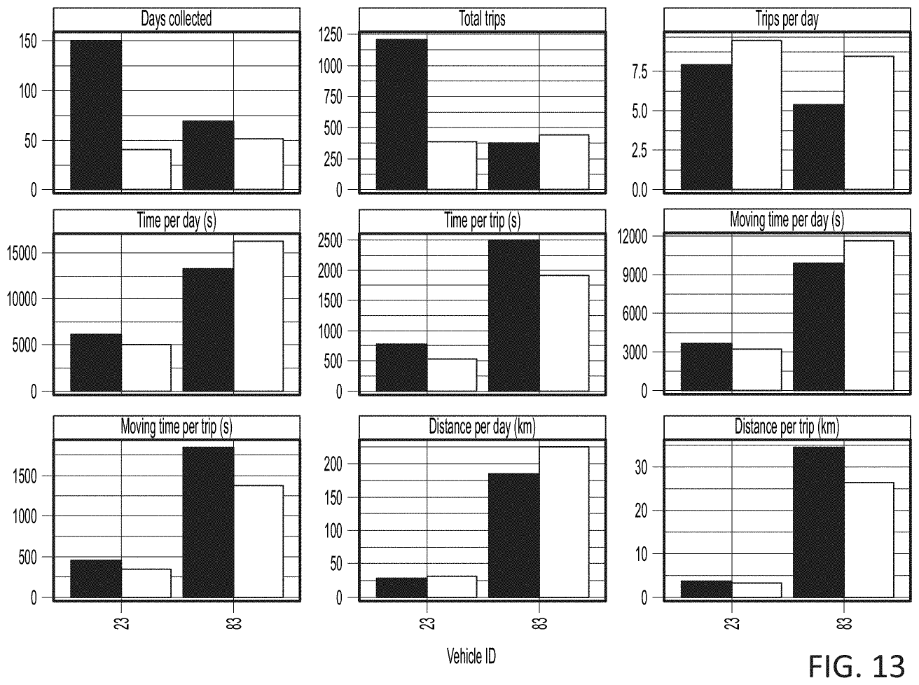

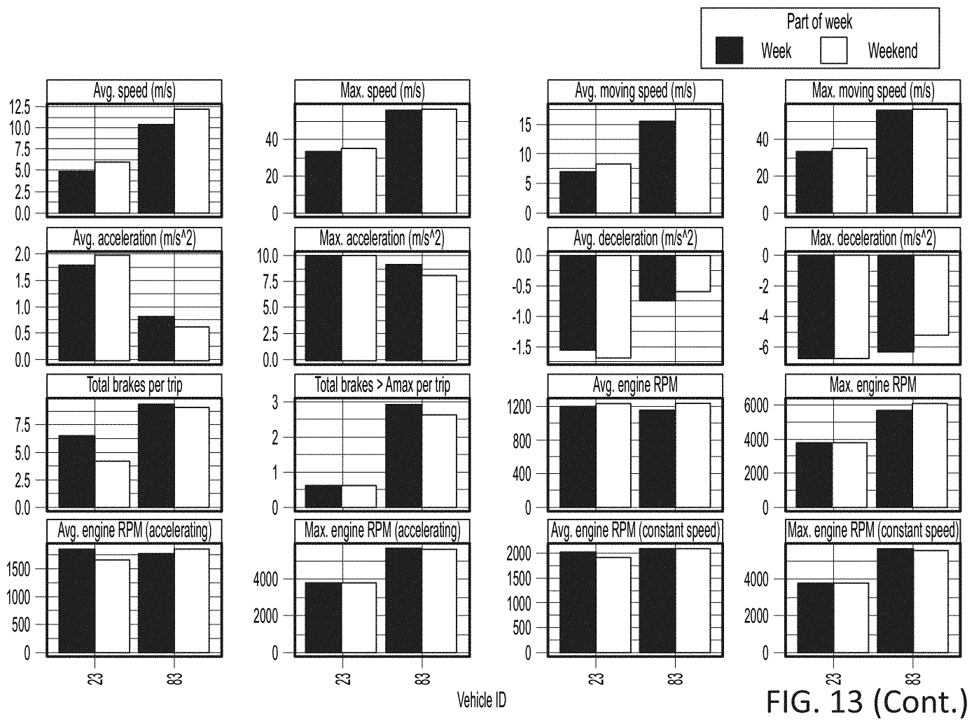

FIG. 13 illustrates how these driving style parameters may be used to determine the driving style of an individual vehicle. For example, Driver 23 (corresponding to the left hand side bars in the bar charts) is shown to take local, short trips, drive at low speeds with aggressive acceleration and braking. In contrast, Driver 83 (corresponding to the right hand side bars in the bar charts) is shown to commute for long journeys at high speeds with passive acceleration and braking. Both drivers make lots of trips at the weekend.

The vehicle repair dataset 15 is shown to comprise a set of repair record(s) 15′, each of which is associated with a VIN, and records at least one repair operation performed on the corresponding vehicle in the population 1P. Each repair record 15′ may comprise a timing value 15A. This can correspond to the time at which the repair operation was actually performed, but this is not essential—it could for example be a later time at which the repair record 15′ was processed, and this can still be used to give reliable results. In this respect, it is noted that where this description refers to the time at which an event occurs, the relevant description applies more generally to the timing associated with that event.

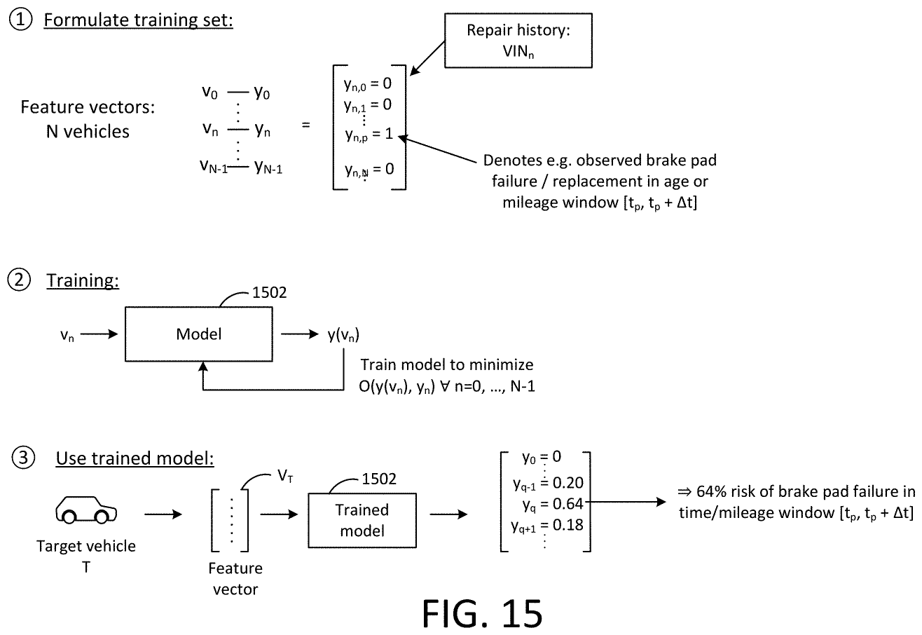

The timing of the vehicle repair can be important in different use cases: as described later, a prediction can be made for a given target vehicle in terms of a risk of repair value, and it may be most appropriate for that value within a window of time or usage (prediction window). Examples of how this can be achieved are described later with reference to FIG. 15.

The repair records 15′ can be in the form of warranty claim or service records. One of the realizations underpinning the described techniques is that, within a predetermined window of a vehicle's “lifetime” (the warranty period), comprehensive data about component faults/failures within that widow is available to the manufacturer. This is because, during that time window, whilst the vehicle is still under warranty, it is the manufacturer who bears the responsibility for such failures/repairs. Likewise, data about component faults/failures may be recorded when the vehicle is serviced.

Each repair record 15′ is shown to comprise at least one repair code (RC) relating to the type of repair operation(s) that was performed as part of the repair event. The RC can for example be a labour operation (LOp) code, identifying a type of labour operation performed, or part code of a faulty vehicle component identified in the repair. Whilst such information can be used to refine the analysis that is performed, it is not in fact essential for the purposes of the invention for the repair record 15′ to identify the type of repair; embodiments of the invention can be implemented using only the associated timing information 15A.

In this example, the datasets 14, 15 are generated by the pre-processing components 8, 9 applying any necessary pre-processing to, respectively, telematics data and vehicle repair data received at the data processing stage to place them in a form that allows them to be used in the manner described below. This can for example include the removal of duplicate or erroneous records, re-formatting, reformulation of telematics data etc. As will be appreciated, the level of pre-processing required will depend on the state of the initial data, and pre-processing may be omitted if the data is received in a sufficiently refined form.

Although not show in FIG. 2, depending on the size of the data sets, an extra pre-processing stage might be required where the data sets are stored in a distributed database and need to be collated together. For real-time analytics, the appropriate software and database structure will be in place for both storage and the predictive elements.

The set of driving style parameters 14 contains one or more of the following example parameters: total journeys, total days, number of journeys per day, time per journey, journey time per day, moving time per journey, moving time per day, distance covered per journey, distance covered per day, average speed, maximum speed, average moving speed, maximum moving speed, average acceleration, maximum acceleration, average deceleration, maximum deceleration, total number of brakes per journey, total number of brakes per day, average engine revolutions per minute (RPM), maximum engine RPM, average engine RPM during acceleration, maximum engine RPM during acceleration, average engine RPM at constant speed, and maximum engine RPM at constant speed.

The respective VINs contained in the driving style parameters and vehicle repair datasets 14, 15 cooperate in that they allow repair operations 15′ recorded in the repair dataset 15 to be matched to corresponding driving style parameters 14 for the same vehicle in the set of driving style parameters 14. A function of the data linking component 10 is to link the repair record(s) 15′ associated with each VIN in the repair dataset 15 to the corresponding set of driving style parameters 14 associated with the matching VIN in the driving style parameters dataset 14.

Linking driving style parameters to repair histories ultimately allows the system to understand the causal relationships between driving style and vehicle fault events. Modern machine learning (ML) techniques can be used to learn these associates in a systematic and automated fashion. As per the examples described below, both supervised and unsupervised learning can be utilized in this context.

Once linked, the sets of driving style parameters and corresponding sets of repair records are used to train a predictive model, which as mentioned above, may be a machine learning model. Regardless of the specific technique used, the predictive model is trained to learn causal connections between driving style parameters and repair records based on the provided training data. For example, the model may be used to determine which driving style parameters are most likely to have caused a historic repair record. As explained below, this is a form of supervised learning where the driving style parameters are used to form input feature objects, such as feature vectors, to the model and the repair history is used to derive expected outputs for the input feature objects. Such feature objects may also be referred to as “driving style profiles” of individual vehicles herein.

The predictive model may go through a number of iterations to correctly train the model. With each iteration, the model takes one or more driving style parameters and predicts a repair operation. The model can be deemed trained when the model correctly predicts repair operations known to be associated with particular driving style parameters. Note that the model does not know with certainty which driving style parameters caused a particular repair operation, but can make predictions with a degree of confidence based on the training data.

A trained model is able to take new inputs and make predictions based on those new inputs and the training data. For example, the model may make a vehicle fault prediction. That is, the model may predict one or more vehicle faults likely to occur with a target vehicle based on a target set of driving style parameters. For example, the model may output a probability of one or more (e.g. all) known repair operations occurring with the target vehicle.

Some specific examples of how different ML model can be applied to the task of making a fault prediction about a target vehicle based on data about the target vehicle, and in particular based on a set of (one or more) driving style parameters determined for the vehicle from its telematics data will now be described. In the following examples, the prediction is a risk value, such as a probability of the vehicle requiring a repair operation. This can be the probability of it requiring any repair operation, or a specific type of repair operation, such as a brake pad replacement. The risk value may be time or usage specific—e.g. a probability (or other risk value) of a vehicle requiring a repair operation within:
a certain interval of (absolute) time, e.g. a particular month;
a certain age range, e.g. when the vehicle is between 18 and 19 months old, as measured from the date it entered active service (which can be determined from the vehicle record if necessary; this can be the date it was sold to the customer); or
a certain usage (e.g. mileage or hourage) range, e.g. when the vehicle has between 1200 and 1400 miles ‘on the clock’.

The following examples are provided as a means of further illustrating certain underlying principles of the invention and its preferred embodiments. However as will be appreciated, these examples are not, and are not intended to be, exhaustive.

Variations that exploit the same or similar underlying principles will become apparent in view of the following description.

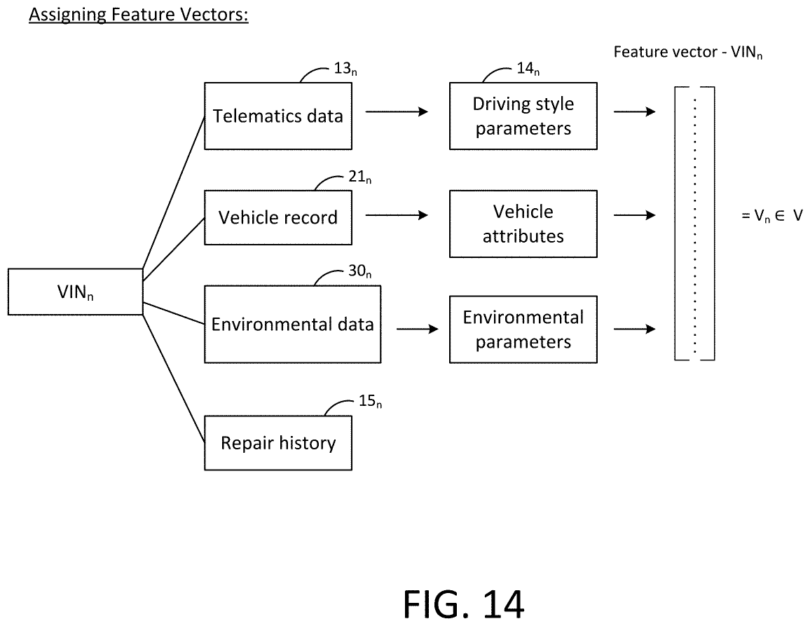

Before describing specific examples of how ML models may be adapted, some of the principles according to which a suitable feature vector may be assigned to a VIN are described with reference to FIG. 14.

The feature vectors are determined for the training population of vehicles 1P by the second processing component 11 of the data processing stage, from the data of the linked dataset 19 in this example.

FIG. 14 shows VINn (for vehicle n in the population), with which are associated telematics data 13n for vehicle n, a vehicle record 21n for vehicle n, environmental data 30n for vehicle n and repair data 15n for vehicle n. The data associated with VINn is used selectively to derive a feature vector vₙ∈V for vehicle n in a feature space V (which is a vector space). The feature space is chosen such that dimensions of the feature space V correspond to data elements that will be available for vehicles about which predictions are going to be made. Thus it would not be appropriate in this instance to populate the feature vector with repair data, because the aim of the task is to allow predictions to be made about vehicle faults for which there is no available repair data.

In this example, the feature vector vₙ is shown as being populated with a mixture of driving style parameters 14n derived from the telematics data 13n; vehicle attributes derived from the vehicle records 21n, such as manufacturer, product group (brand), product, model, model year, age and/or usage; and environmental parameters derived from the environmental data 30, such as average temperature per journey, average number of journeys with precipitation per month, and ‘average’ (e.g. most common) terrain type etc.—on the basis that all of these factors might contribute to the timing and nature of required repairs.

Classification

Classifiers can broadly speaking be broken down into ones that output a probabilistic score e.g. Logistic Regression, and ones that do not e.g. SVM. However, probabilistic classifications can be converted to deterministic results, and there are also methods available to turn a non-probabilistic score into a probabilistic score (or pseudo-probability).

Note that all references herein to vehicle fault probabilities (or similar) given a particular input apply more generally to any significance score denoting the likelihood (in the everyday sense of the work) of a vehicle fault occurring, e.g. within a particular time or usage window, given that input, which can be a probabilistic, pseudo-probabilistic or non-probabilistic result, as derived using any suitable classifier or other suitable model.

Probabilistic Classification

Probabilistic classification is one way in which a risk value can be determined for a given feature vector.

FIG. 15 illustrates an example of how a predictive component (model) in the form of a probabilistic classifier 1502 may be trained to make vehicle fault predictions, using the telematics data 13 and the linked repair data 15 for the vehicle population 1P—denoted vehicles 0 to N−1—as training data (together with the vehicle records 21 and environmental data if used). Steps in FIG. 15 are labelled as numbers in circles (and should not be confused with the un-circled labels used elsewhere).

Although not shown in FIG. 2, the probabilistic classifier 1502 forms part of the second processing component 11.

This is based on supervised learning. The basis of supervised learning is that the model 1502 is trained to learn a function y(v) given a set of example values of y(v)—denoted (y₀, . . . , y_{N}) (the “training labels”)—for respective input vectors (v₀, . . . , v_{N}). Together, these make up a set of training data (training set). Each yₙ value can be thought of as class label assigned to the corresponding input vector vₙ. The power of an ML model is that it is able to generalize from the training set, to give a reliable estimate of y(v) for an input vector v it has not encountered before.

The model 1502 is a computer program that receives x as an input, and transforms it to generate an output y(v), according to a set of electronically stored model 1502 parameters {c₀, . . . , c_{M}}. Strictly speaking, y is a function of v and the model parameters, and thus could be legitimately denoted y(v, c₀, . . . , c_{M}), though that is avoided herein in the interests of conciseness.

During training, the model parameters are recursively adapted, according to a training algorithm, with the objective of minimizing a “loss function”:

O(y(vₙ)−yₙ)

for each (vₙ, yₙ) pairing in the training data, until a set of selected stopping criteria are met. Here, the loss objective function O provides a measure of difference between its inputs. In practice, what is often optimized is a “cost function”, which can comprise an aggregation of the loss functions across the training inputs (with regularization if necessary). A variety of different loss functions can be used, such as mean squared error, cross-entropy etc. One example of a suitable training algorithm is gradient descent, though different training algorithms can be used depending on the context. These are well known per se so are not descried in any further detail.

The training set, that is the feature vectors and their category labels, are determined at Step 1 in FIG. 15.

For the task at hand, feature vectors v₀, . . . , V_{N-1} are derived as described above for vehicles n=0, . . . , N₁.

Time or usage based predictions can for example be handled by defining suitable time or usage-based class (category) labels. For binary classification, the output label y for the ith training example is a 1-d binary label, which it can be convenient to encode as a binary value (0 or 1). For multi-classification, a 1-d output vector can be used for the purposes of collecting and labelling the data e.g. [“a”, “b”, “c”, . . . ]. However, this might be encoded differently for the training phase. For example, for the purposes of probabilistic classification, this can be used to construct a k-dimensional probability vector, where each dimension corresponds to a particular time or usage interval (category) and any dimension that is 1 corresponds to the category to which the training vector belongs. For example, following the above example, if the output label for the ith training example belongs to the set {“a”, “b”, “c” }, each element of that set can be encoded as:

“a”=>[1, 0, 0]

“b”=>[0, 1, 0]

“c”=>[0, 0, 1]

Accordingly, if VINn has experienced a particular vehicle fault event having an associated timing/usage that falls within time (absolute or vehicle age) or usage interval q, e.g.:

[t_{q},t_{q}+Δt]

then its category label q would correspond to a probability vector with the following components:

yₙ=(y_{n,0}, . . . ,y_{n,p})

with:

$${y}_{n , p} = \{ \begin{matrix}1 & for p = q \\ 0 & otherwise\end{matrix}$$

Once the training set has been determined in this manner, then at Step 2, it is used to train the probabilistic classification model 1502, in the manner described above.

With the model 1502 trained then, at Step 3, the trained model 1502 can be used to make a vehicle prediction about a target vehicle T, for which no repair data is available (strictly speaking, for which no repair data is required).

To do this, a feature vector v_{T}∈V is determined for the target vehicle T using the available data, in exactly the same way as the training feature vectors are determined, and inputted to the trained model 1502. The output will be a vector that looks something like:

$$y ( {v}_{T} ) = ( \begin{matrix}{y}_{0} \\ {y}_{1} \\ … \\ {y}_{r - 1} \\ {y}_{r} \\ {y}_{r + 1} \\ …\end{matrix} ) = ( \begin{matrix}0 \\ 0 \\ … \\ 0.20 \\ 0.64 \\ 0.16 \\ …\end{matrix} )$$

(It goes without saying that the numerical values are merely illustrative). Provided a suitable probabilistic classification model is chosen and trained sensibly in accordance with the principles set out above, then each y_{q} value can be interpreted as a probability that the input vector v_{T} belongs to class q, which in turn can be interpreted as the probability of the target vehicle T experiencing whatever repair event is under consideration with a timing or usage value that falls within the corresponding time or usage interval.

So, for example, in the above, there is a ˜64% probability of the target vehicle experiencing whatever vehicle fault is under consideration with an associated timing or usage that falls within the time or usage value interval of class q, however those are defined with reference to the training data. For instance, if the training labels have been assigned to the training data such that vehicles which have experienced a brake pad replacement when the vehicle is between 16 and 17 months old (relative to the date it entered active service), then yᵣ=0.64 can be interpreted as a 64% probability of the target vehicle requiring a break pad replacement at that point in its life.

Mathematically, this can be expressed as a conditional probability:

y_{n,p}=Pr(R_{q}|vₙ)

That is as the probability or vehicle vault event (R_{q}) occurring with an associated timing or usage falling in the interval corresponding to q, given vehicle history vₙ.

Examples of suitable probabilistic classification models include a logistic regression model, a gradient boosting machine, or a neural network with a probabilistic output (e.g. a softmax layer).

Note that the timing or usage associated with a vehicle fault event can be the time or usage value for the vehicle at the time the fault occurred, but it does not have to be. It could for example be the time at which the fault was identified or repaired, or the usage value at that point, the time the fault was logged, or the time at which the corresponding warranty claim was processed (for example). That is, it can be, but need not be, the time at which the fault actually occurred or is believed to have occurred.

Although in above there are multiple classes corresponding to different time/usage intervals, the same principles could also be applied to a simpler binary classification, with the two classes corresponding to (say) a repair having an associated timing/usage in a particular interval and no repair in that interval respectively.

In ML terminology, a distinction is drawn between deterministic classification, in which a feature vector is assigned to a single class, and regression, in which a continuous output value is determined. Under this definition, probabilistic classification is a form of regression, with the continuous output being the class probability value(s). For this particular task, probabilistic classification may be preferred in some contexts, however deterministic classification could also be used, for example to assign a feature vector to one of a set of discrete risk categories, applying the same principles to generate feature vectors using (at least) driving style parameters, and training labels using vehicle fault history. If desired, a probabilistic classifier can be used to implement a discrete classifier, by selecting the highest probability category, or an inherently deterministic classification algorithm can be used.

Driving Style Groups

It can also be useful to evaluate the similarity of driving styles (and other factors too, such as environmental parameters and vehicle attributes) across different vehicles. This can be achieved by using ML techniques to group the feature vectors for the training population 1P. Unsupervised learning, such as clustering, can be used to identify latent groups of the feature vectors. These are referred to herein as “driving style groups”, however as will be appreciated, in the case that the feature vectors comprise other forms of parameter (e.g. environmental parameters and/or vehicle attributes), the groups may not be determined by driving style exclusively as the other factors can also contribute.

That is, a machine learning algorithm can be used to group driving style parameters based on the similarity between the driving style parameters. For example, a classification algorithm may take the driving style parameters as inputs and output a label (sometimes referred to as a category or class) for each parameter. Driving style parameters with the same label or category form a distinct group.

Clustering

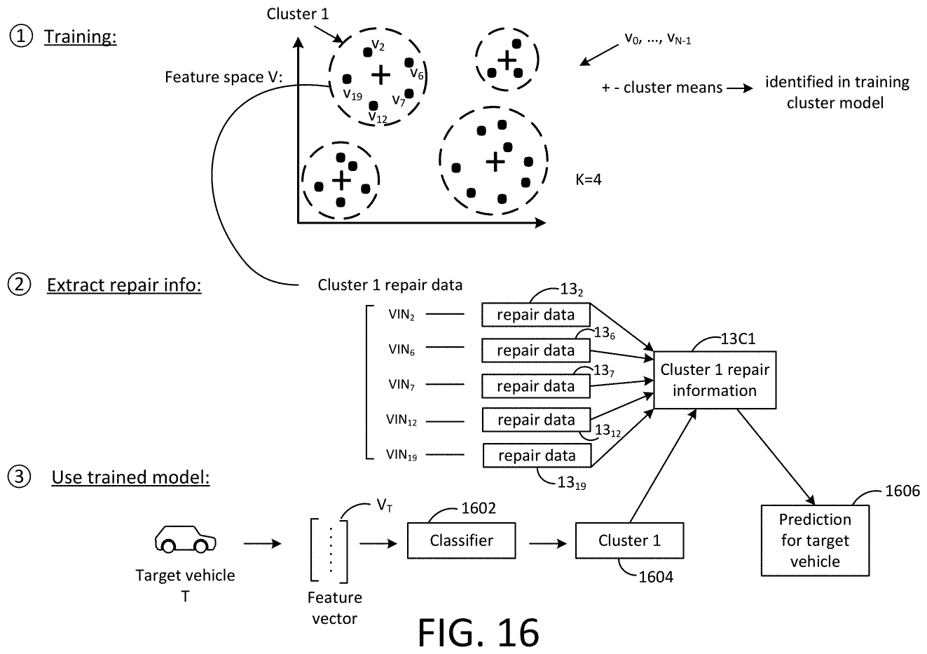

An unsupervised learning example will now be described with reference to FIG. 16. Again, steps are labelled by circles numbers, and even though the same numbers are used as for FIG. 15, these are different steps.

In this example, unsupervised learning is used to categorize the feature vectors v₀, . . . , v_{N-1} (derived as above, with reference to FIG. 14), without reference to the repair data initially.

This is shown at Step 1 in FIG. 16, where in this example k-means clustering is used to identify K latent clusters of the feature vectors. In this example K=4 but this is just an example. K-means clustering is well known per se, therefore it is not described in great depth. Suffice it to say that cluster “means” are identified recursively, which are vectors in V that essentially correspond to the centre-of-mass of each cluster, and the feature vectors are assigned to a cluster based on their proximity to the cluster means.

This can be absolute (e.g. each vector assigned to the closest cluster mean), or probabilistic. These latent clusters are examples of driving style groups as that term is used herein. The underlying idea is to group together ‘similar’ driving styles, taking into account environmental parameters and vehicle attributes, if used (so similar driving styles for similar vehicles under similar environmental conditions).

Once the clusters have been identified, at Step 2, the vehicle repair data 13n for each VINn in a particular cluster can be collated to give overall repair information for the cluster. In this example, VIN 2, 6, 7, 12 and 19 belong to cluster 1, and their repair data is collated to provide collated repair data 13C1 for cluster 1.

At step 3, a k-means (or other cluster-based) classifier 1602 can be used to classify the feature vector v_{T} for the target vehicle T. The cluster-based classifier classifies v in terms of its relation to the latent clusters. In FIG. 16, this is a straightforward classification (e.g. k-nearest neighbour), whereby v_{T} is assigned to whichever cluster mean it is closest to in V, however it could be probabilistic; a probabilistic classifier determined respective matching score between the target input vector v_{T} and the clusters, in the form of a probability value. A prediction about the target vehicle T can then be made based on the output 1604 of the cluster-based classifier, and the collated cluster information (such as 13C1) for the cluster or clusters to which the output 1606 relates.

The prediction could for example be generated as described above with reference to FIG. 15, but with separate probabilistic classifiers being trained for the different clusters, using the data from that cluster only.

Although k-means clustering is used as an example, other forms of unsupervised classification can also be used.

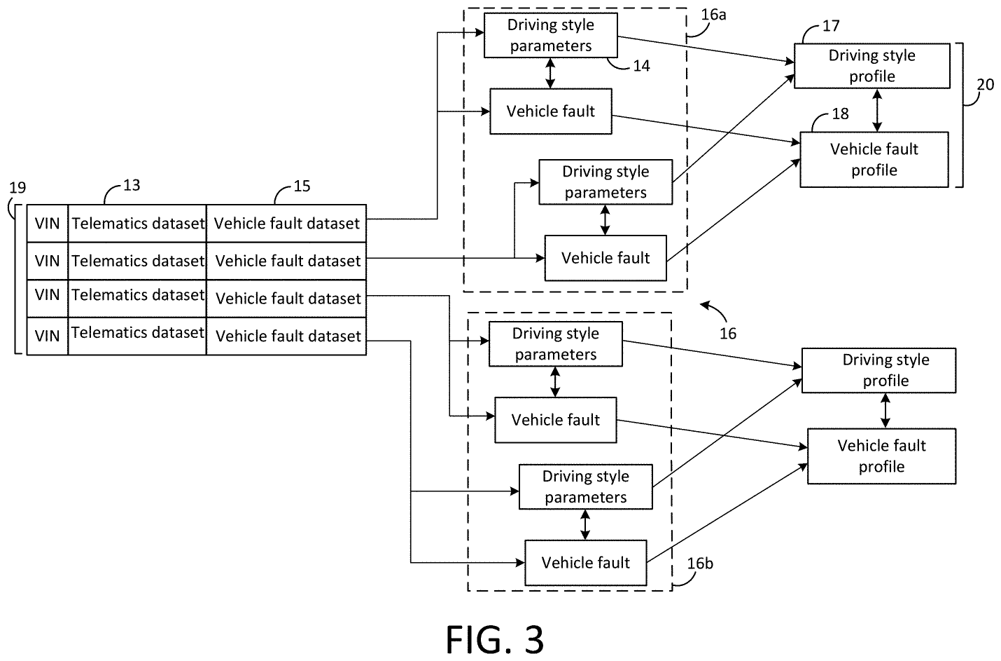

This is one example of a suitable mechanism by which the linked sets 19 of driving style parameters 14 and repair records 15 can be grouped together by the second processing component 11, based on a comparison of at least the driving style parameters 14 in each set. This may also take into account similarity of vehicle attributes and environmental factors, as noted. FIG. 3 illustrates the grouping process in more detail. The sets of driving style parameters 14 are compared with each other, and if there is sufficient similarity between two or more of the sets, those sets are grouped together. In the example of FIG. 3, his results in first and second groups 16a, 16b (collectively labelled 16), but as will be appreciated there may be more groups than this—possibly many more depending on the amount of data available and the depth of analysis desired. Therefore each of the groups 16 contains a plurality of sets of driving style parameters 14 and whatever repair records 15′ were previously linked to those sets 14, 15 by virtue of that linking.

The classification algorithm can be employed to determine similarity and grouping thresholds.

The second processing component 11 takes each group 16 of driving style parameter sets 14 and linked repair record sets 15 and outputs, for each group 16, a representative driving style (behaviour) profile 17 and linked representative repair record profile 18 (collectively labelled 20). For example, each driving style profile 17 may be formed of “typical” driving style parameters derived from the multiple sets of driving style parameters of the respective driving style group 16. The driving style profile 17 may indicate the most prevalent driving style parameters. In another example, the profile 17 may indicate the driving style parameters with values above or below a typical value (or the average value taken from other groups) by a certain amount. That is, a driving style profile 17 may represent groups with, for example, aggressive braking (high number of total brakes per trip) or excessive speeding (large maximum and/or average speed). Similarly, each representative repair record profile 18 represents the repair records 15′ which make up a respective group 16.

A machine learning algorithm, such as a classification or clustering algorithm, may also be used to determine a representative driving style profile from the feature vectors in a particular driving style group.

Matching Profile

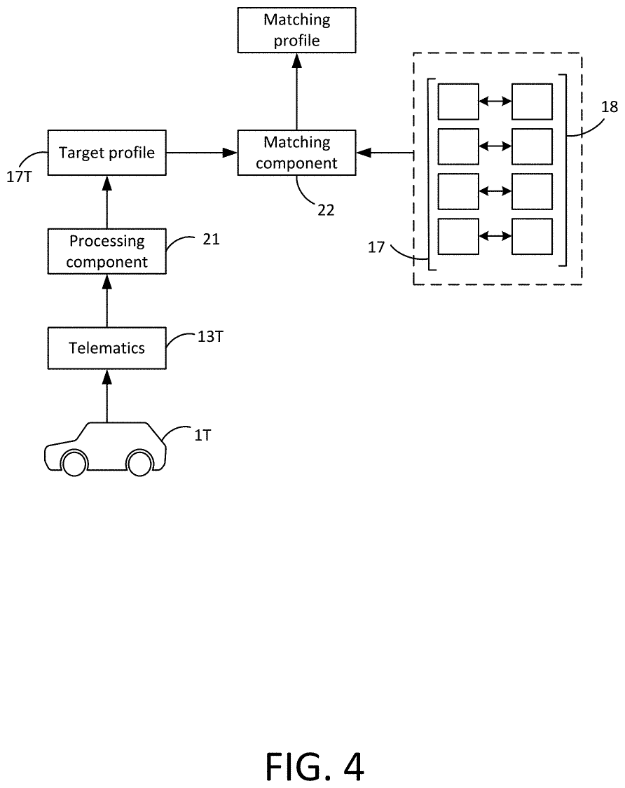

As illustrated in FIG. 4, a third processing component 21 is configured to receive a set of telematics data associated with a target vehicle 1T. The telematics data of the target vehicle 1T may contain raw data collected from the target vehicle 1T. For example, the telematics data may include speed data, acceleration data, engine RPM data, etc. The received telematics data is processed to determine a driving style profile of the target vehicle. The target driving style profile 17T is made up of one or more driving style parameters derived from the telematics data of the target vehicle 1T. For example, the target driving style profile 17T may be determined based on all of the driving style parameters derived from the telematics data of the target vehicle 1T. That is, raw target telematics data 13T is processed to determine target driving style parameters 14T, which are then used to determine a target driving style profile 17T.

A matching component 22 identifies one of the representative driving style profiles 17 that matches with the target driving style profile 17T. For example, the target profile 17T may be representative of a driver driving with aggressive braking. This profile is compared with the representative profiles (which for example may represent excessive speeding, repetitive engine stalling, aggressive braking, driving in lower gears, etc.).

The third processing component 21 and matching component 22 are functional components of the data processing stage, i.e. they represent functions that are carried out according to computer-readable instructions (software) executed on one or more processing units of the data processing stage (such as CPUs, GPUs etc.).

An advantage of identifying a matching profile is that a vehicle fault may be predicted before the fault occurs with the target vehicle. For example, the matching profile is linked with a vehicle fault profile containing one or more commonly occurring vehicle faults. It can therefore be assumed that if a set of vehicles driven in the same style experience the same vehicle fault, a target vehicle driven in a comparable style is also likely to experience that fault. This provides the opportunity for the vehicle to be checked for a vehicle fault, or for a component to be repaired or replaced.

A matching profile may be determined by the predictive model. For example, classification techniques may be used to take the target driving style profile as an input and identify a matching representative driving style profile. In this case, the classification algorithm is assigning a known label (which may denote denoting a particular class/category) to the target driving parameters.

The matching component 22 may determine a matching score between the target style profile 17T and the matching representative driving style profile 17. That is, the matching score may be a measure of similarity between the two (target and matching) style profiles.

For example, the classification model may predict a continuous value as the probability of a target driving style profile belonging to each representative driving style profile. The probabilities can be interpreted as the likelihood or confidence of the target driving style profile belonging to each class (i.e. each representative driving style profile). A predicted probability can be converted into a class value by selecting the class label that has the highest probability. That is, the representative driving style profile with the highest probability is identified as the matching profile.

Whilst any number of representative driving style profiles 17 may be determined, the matching driving style profile may not be an exact match to the target driving style profile 17T. For example, the target and matching profile may have some common features whilst they may also differ in some aspects. An advantage of the matching score is that the user can, based on the score, easily determine how similar the profiles are. If the profiles have a high matching score, the profiles are very similar and therefore the target vehicle 1T is likely to experience one of the vehicle faults from the linked vehicle fault profile.

In the example of FIG. 2, the data linking component 10 is also shown having an input to receive vehicle records 21 relating to the population of vehicles 1P. These can be records that are created when each of the vehicles commenced active service. By matching the VINs to VINS of the vehicle records 21, the data linking component 10 can additionally augment the records of the linked dataset with vehicle data derived therefrom, although this not shown explicitly in FIG. 2.

The vehicle records 21 can be sales records created when the vehicles are sold. Sales records are a convenient instrument for collecting comprehensive data about vehicles commencing active service, however any suitable form of vehicle records can be used.

The vehicle records 21 can also be updated when a vehicle is, for example, repaired or serviced. For example, a current mileage may be updated during a service of the vehicle.

It is noted that, whilst vehicle records 21 relate to the same population of vehicles 1P, they are generally collected at different times than the repair and telematics datasets 15, 14 from different (sometimes disparate) sources. The use of VINS in these datasets make this possible, as it allows the disparate records to be linked.

In some examples, the vehicle records 21 (or more particularly the vehicle attributes recorded in those datasets) are used to determine more specific driving style groups. The vehicle attributes may be for example, the make and/or model of the vehicle, the age of the vehicle (e.g. a sale record), a vehicle mileage, an engine type, a transmission type, etc. When determining the plurality of driving style groups 16, not only are sets of driving style parameters between groups compared 14, the vehicle attributes are also compared. For example, groups 16 may be formed of vehicles with matching manufacturers, or similar engine sizes, or similar chassis types, e.g. hatchback, coupe, saloon. As an example, a group 16 may be made up of driving style parameters (e.g. high average acceleration values) coupled with BMW vehicles, whilst another group may be made up of the same driving style parameters (high average acceleration values) coupled with Ford vehicles. Another group may be made up of BMW vehicles with a different driving style parameter (e.g. low average acceleration values).

An advantage of this sub-group analysis is that the representative driving style profiles 17, each of which is based on a respective driving style group 16, are thereby made more specific. As each driving style style profile 17 is linked with a vehicle fault profile 18, the faults linked with a style profile are made more specific to that profile. For example, a driving style profile representative of heavy acceleration may have an associated fault (e.g. transmission damage). However, that driving style profile 17 may be made up of a range of different transmission systems, e.g. from different manufacturers. It may be that only certain types of transmission systems suffer from damage at the level of heavy acceleration of that profile. So, if the groups are formed based on the transmission type, the profiles derived from these groups are split. The result is that one profile may be linked with the transmission damage, whilst another profile is not.

Similarly, the target driving style profile 17T of the target vehicle may be based on the vehicle attributes 21T (received at the processing stage) of the target vehicle 1T. A benefit of this is that the target driving style profile may be matched to a more specific representative driving style profile 17. This results in predicting linked vehicle faults which are more specific to the target vehicle.

Vehicle Fault Risk

As an optional feature, the representative historic vehicle fault profile linked to the matching representative driver style profile may be used to determine a significance value denoting the probability (or likelihood) of a type of vehicle fault occurring with the target vehicle. That is, the risk of a particular fault occurring in the target vehicle may be calculated. The risk may be of a particular vehicle component (e.g. brake pads, head gasket, starter motor, etc.) failing partially or completely, or the probability that the component will need replacing. For example, the probability of the brake pads of a vehicle requiring replacement may be calculated. In some examples, the probability of a vehicle fault occurring after a given time period (e.g. hours of use), or mileage period, may be calculated. The vehicle fault type corresponds to a vehicle fault contained in the representative vehicle fault profile.

As discussed above, each driving style profile is linked to a vehicle fault profile, with each vehicle profile containing a set of repair records. As shown in FIG. 2, each repair record contains a repair code relating to a specific repair operation performed on a historic vehicle. Therefore a matching driving style profile (i.e. one of the driving style profiles determined to match the target driving style profile) is linked with a corresponding set of repair codes. The probability of a specific fault occurring relating to one of the repair codes in the linked vehicle fault profile may be determined. That is, a vehicle fault profile may contain repair records relating, for example, to brake pad replacement, wheel alignment, gearbox replacement, exhaust repair. The risk of the target vehicle requiring one or more of brake pad replacement, wheel alignment, gearbox replacement, exhaust repair is then determined.

Any number of machine learning techniques (e.g. logistic regression, gradient boosting machines, neural nets, etc.) can be applied to an historic training dataset of multiple vehicles described by a set of input parameters (e.g. vehicle age, avg. speed, number of hard brakes, etc.) to determine a risk score for a particular outcome (e.g. claim in the following week) of interest.

The risk value can be calculated by applying a machine learning technique such as, for example, logistic regression, gradient boosting, neural networks, etc., to the training data.

For example, a logistic regression technique may be used. For example, the set of driving style parameters derived from the historic telematics data are used as training data. The driving style parameters are independent variables. The linked vehicle fault events are the associated outcome dependent variables. The goal of logistic regression is to construct a model that explains the relationship between the independent variables and the outcome dependent variables, so that the outcome of a new “experiment” can be correctly predicted for a new data point for which the independent variables, but not the outcome, are available. The predictive model is trained on the training data until the vehicle fault events are correctly predicted from the driving style parameters.

The target vehicle may be equated with the new data point, with the target driving style parameters (and/or the target driving style profile) used as the new independent variables input to the trained model. The trained model outputs one or more of the dependent variables (outcomes) with an associated probability of that outcome. That is, the trained model predicts the likelihood of a vehicle fault event occurring with the target vehicle.

The risk value may be the risk of the vehicle fault occurring within a given period of time or within a given usage period, given the target driving style parameters and/or profile. The usage period may, for example, a “period” of mileage, or a number of hours of use (e.g. number of hours whilst driving).

As another example, the trained model may be used to determine an estimated cost of (resource value for) repairs for the target vehicle. For example, each historic vehicle fault event may include a cost of repair for that particular vehicle fault. Cost is a useful metric in this context because it is a reasonably reliable indicator as to the severity of the issue. The model may be trained to correctly predict the repair cost of each historic vehicle based on the training data. The trained model may then be used to predict the cost of repairs for the target vehicle, e.g. occurring within the next year, based on the target driving style parameters.

The same principles as described above in relation to FIGS. 15-16 can be applied in relation to repair cost. In this context, the problem could be formulated a general regression problem (rather than probabilistic classification as such), where the model is trained to output a cost estimate, which may be time or usage specific, that is corresponding to the expected cost for a particular time or usage period. In that case, the training labels can comprise recorded cost values for the historic repair operation. Alternatively, this could be classification based (probabilistic or deterministic), which would work by assigning feature vectors to defined cost categories.

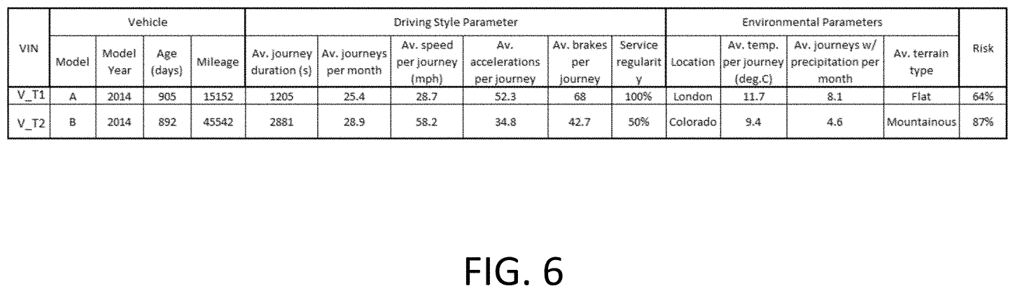

FIG. 6 illustrates an example of determining the probability of two target vehicles requiring a brake pad replacement. In this example, vehicles associated with VIN 1 and VIN 2 each have a respective set of target driving style parameters and target vehicle attributes, which are collectively used to determine a respective target driving style profile 17T for each vehicle. In this example, the vehicle identified by VIN 2 has a target driving style profile matched with one of the representative driving style profiles 17 determined from a particular driving style group 16, which in turn was determined from the data collected from the population of vehicles 1P. The matching driving style profile 17a contains aggregated driving style parameters and aggregated vehicle attributes from the driving style group 16. The matching driving style profile 17a is linked with a vehicle fault profile 18a which contains a set of repair codes. Each repair code relates to a repair operation linked with a driving style parameter in the driving style profile 17 linked to the vehicle fault profile 18a. As shown, each repair code is associated with a determined probability (risk value) from a set of risk values, the probability representing the likelihood of the vehicle requiring a repair related to the respective repair code.

In the example of FIG. 6, the risk of a particular repair operation (e.g. brake pad replacement) for the target vehicle associated with VIN 2 is determined to be 87%. This risk is taken from the set of risk values in the vehicle fault profile 18a of the matching driving style profile 17a. By calculating the probability of a specific vehicle fault type occurring, the user of the target vehicle 1T (e.g. the driver or manufacturer) can be made aware of not only if a vehicle fault is likely to occur, but also the particular type of fault. This allows the user to take preventative action to repair or replace a particular component that is deemed likely to fail. Alternatively, each vehicle fault profile may contain a single risk value, the single risk value representing the probability of the vehicle requiring any repair operation (or undergoing any component fault or failure).

A benefit of this telematics based approach is that it allows preventative maintenance to be performed at the component level on a per-vehicle basis, based on how that vehicle has been driven compared to other (similar) vehicles. For example, where it can be seen that an individual vehicle has been driven in the same way that a number of vehicles have been, and those vehicles have all experienced the same or similar vehicle fault, one can take preventative action to prevent that same fault occurring. This approach can take into account the type of failure (e.g. how severe will the consequences of not taking preventative action be) and also the similarity between the style profiles and the number of linked faults (e.g. how confident should the user be that the fault will occur).

In other words, this allows issues with individual vehicles to be detected earlier than would otherwise be the case. This in turn allows any necessary repair/replace operations to be scheduled in advance in an appropriate manner, e.g. alongside other planned maintenance work or during normal operational hours, with less vehicle downtime (as opposed to those repair/replace operations being driven be vehicle breakdown, as might otherwise be the case, for example).

To take an extreme example, if a target driving style profile 17T has a matching score of 95% with a matching representative driving style profile, and there is a 90% risk of the brake pads requiring replacement, the user can be sufficiently confident that the brake pads are likely to need replacing. Instead of waiting until the brake pads fail, the user can instead replace the brake pads and prevent any further damage to the car, or reduce the risk of an associated accident occurring. This is contrast to reactive action which would result in the brake pads being replaced only after the user becomes aware due to, e.g. brake failure.

By detecting the issue earlier, at the very least, this allows a maintenance operation to be scheduled for the vehicle at a convenient time (rather than having to perform maintenance in response to the failure), and in some cases, if a fault can be detected earlier it may be less burdensome to repair.

Environmental Factors

The example of FIG. 6 also illustrates how environmental parameters can influence the determined risk value. That is, environmental parameters associated with the population of vehicles 1P and also for the target vehicle 1T may be received at the data processing stage. Environmental parameters may include, for example, a geographical location (e.g. town, city, country) in which a vehicle is registered or most often driven. Further examples of environmental parameters include weather parameters such as, for example, average journey temperature, maximum journey temperature, average daily temperature, maximum daily temperature, average journey rainfall, maximum journey rainfall, average daily rainfall, maximum daily rainfall, average number of journeys with precipitation, average terrain type, etc. These environmental parameters may be linked with vehicle repair records using VINs in a similar manner as discussed above in relation to vehicle attributes.

In examples, in addition to driving style and vehicle attributes, the grouping may also take into account environmental factors associated with the vehicles, such that each group corresponds not only to a particular driving style and optionally a particular type or class of vehicle, but also the type of weather or terrain the vehicle is driven in. For example, groups 16 may be formed of vehicles driven in matching temperature, humidity, terrain, etc.

The determined driving style profiles may therefore be based on these environmental factors. Similarly, the target driving style profile may be based on environmental factors, as shown in FIG. 6.

Vehicle Alerts

One possible way of driving preventative maintenance is to provide an early-warning system based on alerts driven by a vehicle's telematics activity, that can be used in conjunction with an OBD-capable vehicle of the kind described with reference to FIG. 1.

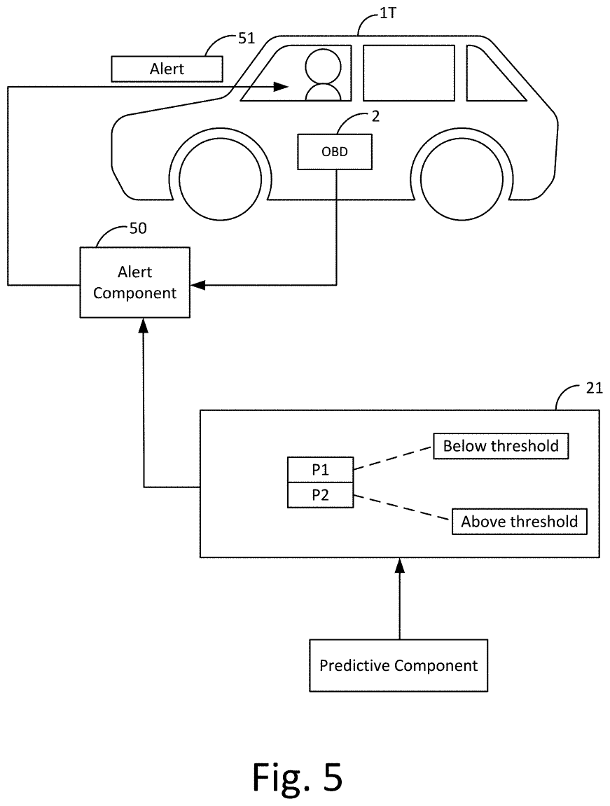

FIG. 5 shows a schematic block diagram corresponding to this use case, in which real-time alerts are selectively generated based on the results of the predictive analysis. In this simple example, an alert component 50 is configured to provide an alert if the determined probability of a vehicle fault type occurring with the target vehicle 1T being above a threshold value. The alert component 50 is communicatively coupled to the OBD system 2 of the vehicle 1T for receiving telematics data from which a driver profile can be determined. When a probability of a required repair operation (or the risk of a component failure) above the threshold value P1 is determined, the alert component 50 generates an alert 51 in response. The alert 51 is generated and outputted to a user of the vehicle 1T in this example, for example via the vehicle's dashboard. By contrast, when a determined probability/risk is below a threshold P2, the alert component 50 does not generate an alert.

In some examples, the alert component may output an alert detailing the target driving style profile. The alert may contain one or more driving style parameters of the target vehicle, such as, the maximum acceleration. This may prompt the user of the vehicle to adjust their driving style and reduce the likelihood of component failure/damage.

The alert 51 may identify the type of vehicle fault that is expected to occur based on the matching driving style profile and linked vehicle fault profile. In some examples, the alert 51 may comprise the matching score. This may provide the user with a confidence in the degree of similarity between the target and matching driving style profiles.

The alert component 50 can be implemented within the vehicle 1T itself, or it can be a remote component that the vehicle communicates with wirelessly, for example.

As will be appreciated, this simple thresholding is just one example of how the alert component 50 can be configured using the results of the predictive analysis. The criteria according to which the alert component 50 is configured based on the probability value(s) can be more refined than this. The alert component 50 can be configured automatically using the results, but there may be a degree of manual oversight (for example, in selecting the rules according to which the alert component 50 is configured based on the probability value(s)).

The benefit of this approach is that the user is only alerted to probabilities imply a sufficiently high probability of the vehicle 1T requiring preventative maintenance.

In other cases, the alert 51 could be output elsewhere, not necessarily to the driver (e.g. it could be outputted to a vehicle fleet operator or manager), and need not be outputted in real-time.

Generally a user interface (comprising an output device, such as a display etc., and an input device, such as a touchscreen, mouse, track pad etc.) can be used to access any of the information computed at the data processing stage, for use in making vehicle predictions.

Extensions:

To further illustrate how the teaching presented herein can be extended to other models, it is useful to consider the general steps involved from receiving the telematics and claims data sets and arriving at an end solution, which could be real-time or not.
1. Telematics data and claims data received. They may be stored in the same database or have separate databases depending on size of data, etc. The telematics data sets could be sensor readings and/or diagnostic trouble codes. The columns in the telematics data sets will have similarities between each company but will not be a predetermined set of columns.
2. At this stage, without any linkage between the telematics and claims data, it is possible to do various types of data analysis such as statistics, unsupervised machine learning, topological data analysis, etc. If the data is large enough that it needs to be stored in a distributed database, an extra layer of complexity exists to be able to do the analysis, as the data needs to be collated from multiple sources. Similarly if the analysis is in real-time.
3. Linking the data sets provides telematics history on vehicles and information on whether or not the vehicles/parts experience a failure or not, and their respective costs. This opens up the possibility of predicting if a vehicle/part will experience a failure or not using techniques such as supervised machine learning.
4. When building models using supervised ML, extra features may be crafted from the original columns in the telematics data sets together with external data. Each algorithm will have different input features requirements e.g. DTC counts for Bayes, sequences for RNNs (recurrent neural networks), driving style parameters as described above etc. For predicting vehicle failure, the output variable (which is a training label, referred to herein as a “significance label”) could be:
   a. binary e.g. failure within a month or not
   b. multiclass e.g. failure within various time intervals
5. Once the model is built, has achieved acceptable performance, the model can be deployed to predict vehicle failure on new, unlabelled data. Again, this could be real-time or daily/weekly updates, etc.
6. The model may be re-trained, and this could be offline or online training/learning.
7. Displaying the analysis and predictive results, a front-end which displays the results may be provided.

That is to say, in general, a significance value can be assigned by the trained model to an unlabelled portion of vehicle diagnostics data. The significance value indicates how significant it is in terms of its expected consequences with regards to vehicle fault events. The model is trained using equivalent but labelled pieces of vehicle diagnostics data, where the significance label to it captured what the relevant consequences, in terms of vehicle fault events, actually were for that portion of data.

For each vehicle in the training population, at least one portion of diagnostics data collected from it is assigned a significance label, which is determined in dependence on any vehicle fault event experienced by that vehicle within a prediction time window. That is, based on any vehicle fault data available for that vehicle within the prediction time window. The prediction time window can be defined relative to the portion of diagnostic data in question.

Although the technology has been described in relation to vehicles, the technology can also be applied to other forms of machine.

Another aspect of the present invention provides a computer-implemented method of predicting machine faults, the method comprising implementing, at a data processing stage, the following steps: receiving diagnostics data collected from a plurality of machines; receiving machine fault data recording fault events experienced by the machines; for each of the machines, determining, for at least one piece of diagnostics data collected from that machine, a significance label (training label) based on the machine fault data for that machine; and using the pieces of diagnostics data and their significance labels to make a machine fault event prediction for a target piece of diagnostics data.

Although specific embodiments of the inventions have been described, variants of the described embodiments will be apparent. The scope is not defined by the described embodiments but only by the accompanying claims.

1.-48. (canceled)

49. A computer-implemented method of predicting vehicle faults, the method comprising:
receiving at a computer system: i) sets of telematics data each associated with a vehicle identifier, and ii) a vehicle fault dataset, which records historic vehicle fault events, wherein the historic vehicle fault events are associated in the datasets with cooperating vehicle identifiers;
for each of the vehicle identifiers, determining i) a feature object by processing the associated set of telematics data to determine at least one driving style parameter therefrom, the feature object comprising the at least one driving style parameter, and ii) a training label for the feature object based on one or more of the historic vehicle fault events associated with that vehicle identifier; and
using the feature objects and their training labels to train a predictive component to learn causal associations between the driving style parameters and the historic vehicle fault events, such that a feature object comprising at least one target driving style parameter, associated with a target vehicle, inputted to the trained predictive component causes the predictive component to output a corresponding vehicle fault prediction.

50. The method of claim 49, comprising:
inputting a feature object comprising the target set of driving style parameters to the trained predictive component; and
outputting the corresponding vehicle fault prediction, by the predictive component.

51. The method of claim 50, wherein the vehicle fault prediction is outputted to a user via an output device.

52. The method of claim 49, wherein the corresponding vehicle fault prediction comprises a significance value denoting a likelihood of a vehicle fault occurring with the target vehicle.

53. The method of claim 52, wherein the training labels are determined based on respective types of the historic vehicle fault events such that the significance value denotes a likelihood of a specific type or types of vehicle fault event occurring.

54. The method of claim 52, wherein the training labels are determined based on timing or usage values associated with the historic vehicle fault events such that the significance value denotes a likelihood of the specific type or types of vehicle fault occurring within the target vehicle within a predetermined period of time and/or a predetermined usage interval.

55. The method of claim 54, wherein the training labels are vectors having components corresponding to different time or usage intervals.

56. The method of claim 49, wherein the training labels are determined based on recorded resource values for the historic vehicle fault events such that the corresponding vehicle fault prediction is an expected vehicle fault resource value for the target vehicle.

57. A system for predicting vehicle faults, the system comprising:
a computer interface configured to receive: i) sets of telematics data each comprising a vehicle identifier, and ii) a vehicle fault dataset, which records historic vehicle fault events, wherein the vehicle fault events are associated in the datasets with cooperating vehicle identifiers;
at least one processor; and
a memory configured to store executable instructions which, when executed on the at least one processor, cause the at least one processor to:
process each of the sets of telematics data to determine a feature object comprising at least one driving style parameter;
group the feature objects into a plurality of driving style groups, by comparing at least the driving style parameters of the feature objects; and
link each of the driving style groups with one or more of the historic vehicle fault events based on the associated vehicle identifiers.

58. The system of claim 57, wherein the at least one processor is configured to receive a feature object of a target vehicle comprising at least one driving style parameter, match the feature object of the target vehicle to at least one of the driving style groups, output a vehicle fault prediction for the target vehicle based on the vehicle fault events linked to the at least one driving style group, and determine the feature object for the target vehicle by processing a set of telematics data received for the target vehicle.

59. The system of claim 57, comprising a user interface for accessing vehicle fault information for each of the driving style groups, the vehicle fault information being derived from the one or more vehicle fault events to which the driving style group is linked.

60. The system of claim 57, wherein the at least one processor is configured to group the feature objects using an unsupervised machine learning algorithm.

61. The system of claim 57, wherein the at least one processor is configured to aggregate constituent driving style parameter sets of each of the driving style groups to determine a representative driving style profile for that driving style group.

62. The system of claim 57, wherein the at least one processor is configured to aggregate, for each of the driving style groups, the historic vehicle fault events linked to it, to determine a representative historic vehicle fault profile, wherein the vehicle fault prediction is based on the representative historic vehicle fault profile of the at least one driving style group.

63. The system of claim 62, wherein the vehicle fault prediction comprises a likelihood of at least one type of vehicle fault occurring with the target vehicle, wherein the likelihood is determined based on the representative historic vehicle fault profile of the at least one driving style group.

64. The system of claim 57, wherein the at least one processor is configured to implement a plurality of predictive components, each corresponding to one of the driving style groups, wherein each of the predictive components is trained using the feature objects of the driving style group to which is corresponds and the one or more vehicle faults linked to that group, wherein the one or more vehicle faults are used to determine training labels for that driving style group.

65. The system of claim 57, wherein each of the feature objects also comprises at least one vehicle attribute and/or at least one environmental parameter.

66. The system of claim 65, wherein each of the feature objects also comprises the at least one vehicle attribute, and the at least one vehicle attribute comprises at least one of: i) an age of the vehicle, ii) a mileage of the vehicle, iii) a vehicle manufacturer, iv) a vehicle model, v) a vehicle engine type, and vi) a vehicle transmission type.

67. The system of claim 57, wherein the driving style parameters comprise at least one selected from the group consisting of: a vehicle speed metric, a driving distance metric, an vehicle acceleration metric, a vehicle engine metric, a vehicle braking metric, a total number of journeys, a total number of days, a number of journeys per day, a time per journey, a journey time per day, a moving time per journey, a moving time per day, a distance covered per journey, a distance covered per day, an average speed, a maximum speed, an average moving speed, a maximum moving speed, an average acceleration, a maximum acceleration, an average deceleration, a maximum deceleration, a total number of brakes per journey, a total number of brakes per day, an average engine revolutions per minute (RPM), a maximum engine RPM, an average engine RPM during acceleration, a maximum engine RPM during acceleration, an average engine RPM at constant speed, and a maximum engine RPM at constant speed.

68. At least one non-transitory computer readable medium having stored thereon computer readable instructions that, when executed on one or more computer processors, implement operations comprising:
receiving i) sets of telematics data each associated with a vehicle identifier, and ii) a vehicle fault dataset, which records historic vehicle fault events, wherein the historic vehicle fault events are associated in the datasets with cooperating vehicle identifiers;
for each of the vehicle identifiers, determining i) a feature object by processing the associated set of telematics data to determine at least one driving style parameter therefrom, the feature object comprising the at least one driving style parameter, and ii) a training label for the feature object based on one or more of the historic vehicle fault events associated with that vehicle identifier; and
using the feature objects and their training labels to train a predictive component to learn causal associations between the driving style parameters and the historic vehicle fault events, such that a feature object comprising at least one target driving style parameter, associated with a target vehicle, inputted to the trained predictive component causes the predictive component to output a corresponding vehicle fault prediction.
